(19) United States
(12) Patent Application Publication
(10) Pub. No.: US 2024/0257326 A1
(43) Pub. Date: Aug. 1, 2024

(54) STORAGE MEDIUM STORING PROGRAM AND IMAGE PROCESSING APPARATUS

(71) Applicant: BROTHER KOGYO KABUSHIKI KAISHA, Nagoya (JP)

(72) Inventor: Masaki KONDO, Toyoake (JP)

(21) Appl. No.: 18/423,465

(22) Filed: Jan. 26, 2024

(30) Foreign Application Priority Data
Feb. 1, 2023 (JP) 2023-014105

(51) Int. Cl. G06T 7/00; G06T 3/04; G06T 3/40; G06T 3/60; G06V 10/75

(52) U.S. Cl. CPC G06T 7/0002; G06T 3/04; G06T 3/40; G06T 3/60; G06V 10/751; G06T 2207/20048; G06T 2207/30168

(57) ABSTRACT

A set of program instructions, when executed by a processor of a computer, causes the computer to perform: acquiring a two-dimensional captured image of a particular surface of a target object; keypoint matching between the two-dimensional captured image and a two-dimensional normal image representing a normal particular surface; generating a transformed image by performing homography transformation on a first image in accordance with a result of the keypoint matching, the first image being one of the two-dimensional captured image and the two-dimensional normal image; and determining whether the particular surface of the target object has an abnormality by comparing a second image with the transformed image, the second image being an other one of the two-dimensional captured image and the two-dimensional normal image.

### REFERENCE TO RELATED APPLICATIONS

This application claims priority from Japanese Patent Application No. 2023-014105 filed on Feb. 1, 2023. The entire content of the priority application is incorporated herein by reference.

### BACKGROUND ART

An image of an object (for example, a label sheet affixed to a product such as a multifunction peripheral) is used to determine whether the object has an abnormal visual.

### SUMMARY

For example, an image of a label sheet is input to a machine learning model to generate an image of the label sheet without defects. The degree of abnormality is calculated using difference image data representing a difference between the input image and the generated image.

Here, there is room for improvement in the process for determining whether an object has an abnormality.

In view of the foregoing, an example of an object of this disclosure is to provide a new technique for determining whether an object has an abnormality.

According to one aspect, this specification discloses a non-transitory computer-readable storage medium storing a set of program instructions for a computer including a processor. The set of program instructions, when executed by the processor, causes the computer to acquire a two-dimensional captured image of a particular surface of a target object. Thus, the computer acquires the two-dimensional captured image of the particular surface of the target object. The set of program instructions, when executed by the processor, causes the computer to perform keypoint matching between the two-dimensional captured image and a two-dimensional normal image representing a normal particular surface. Thus, the computer performs keypoint matching between the two-dimensional captured image and the two-dimensional normal image. The set of program instructions, when executed by the processor, causes the computer to generate a transformed image by performing homography transformation on a first image in accordance with a result of the keypoint matching, the first image being one of the two-dimensional captured image and the two-dimensional normal image. Thus, the computer generates the transformed image. The set of program instructions, when executed by the processor, causes the computer to determine whether the particular surface of the target object has an abnormality by comparing a second image with the transformed image, the second image being an other one of the two-dimensional captured image and the two-dimensional normal image. Thus, the computer determines whether the particular surface of the target object has an abnormality. According to this configuration, since it is determined whether the particular surface has an abnormality by comparing the second image with the transformed image acquired by the homography transformation, appropriate determination is performed.

According to another aspect, this specification also discloses a non-transitory computer-readable storage medium storing a set of program instructions for a computer including a processor. The set of program instructions, when executed by the processor, causes the computer to acquire a two-dimensional captured image of a particular surface of a target object. Thus, the computer acquires the two-dimensional captured image of the particular surface of the target object. When executed by the processor, causes the computer to perform an abnormality determination process of determining whether the particular surface of the target object has an abnormality by comparing the two-dimensional captured image with a two-dimensional normal image representing a normal particular surface. Thus, the computer determines whether the particular surface of the target object has an abnormality. The abnormality determination process includes acquiring, from the two-dimensional captured image, N (N is an integer greater than or equal to two) first type partial images including different portions of a first type particular surface. The first type particular surface is a particular surface represented by the two-dimensional captured image. Thus, the computer acquires, from the two-dimensional captured image, the N first type partial images including different portions of the first type particular surface. The abnormality determination process includes performing keypoint matching between a first type partial image and a second type partial image associated with each other. Each of N combinations including the first type partial image and the second type partial image associated with each other. N second type partial images include different portions of a second type particular surface. The second type particular surface is a particular surface represented by the second image. The first type partial image and the second type partial image associated with each other include a common portion. Thus, the computer performs keypoint matching between the first type partial image and the second type partial image associated with each other. The abnormality determination process includes calculating N homography matrices in accordance with N results of the keypoint matching. Thus, The N homography matrices are calculated in accordance with N results of the keypoint matching. The abnormality determination process includes calculating a degree of difference between an identity matrix and each of the N homography matrices. Thus, the computer calculates the degree of difference between the identity matrix and each of the N homography matrices. The abnormality determination process includes determining whether the particular surface of the target object has an abnormality by comparing each of N degrees of difference with a reference for the degree of difference. Thus, it is determined whether the particular surface of the target object has an abnormality. According to this configuration, whether the target surface has an abnormality is appropriately determined by comparing the degree of difference between the homography matrix and the identity matrix with the reference for the degree of difference.

The technology disclosed in the present specification may be realized in various aspects, and may be realized in the form of, for example, an image processing method and an image processing apparatus, a computer program for realizing the functions of the method or apparatus, a storage medium (for example, a non-transitory storage medium) in which the computer program is recorded, and so on.

### BRIEF DESCRIPTION OF DRAWINGS

FIG. 1 is an explanatory diagram showing a data processing apparatus.

FIG. 2A is a perspective view of a product 300.

FIG. 2B is a diagram showing an example of a label L.

FIG. 3 is a flowchart showing an example of an inspection process.

FIG. 4A is a diagram showing an example of a captured image (shot image).

FIG. 4B is a diagram showing an example of keypoints detected from a captured image ip.

FIG. 4C is a diagram showing an example of a normal image.

FIG. 4D is a diagram showing an example of a result of keypoint matching.

FIG. 5A shows an example of a homography matrix.

FIG. 5B shows an example of homography matrices representing coordinate transformation.

FIG. 5C shows an example of a transformed image.

FIG. 6 is a flowchart showing an example of an abnormality determination process.

FIGS. 7A, 7B, 7C, 7D, 7E and 7F are explanatory diagrams of a plurality of block images.

FIGS. 7G and 7H are diagrams showing examples of results of keypoint matching.

FIG. 8 shows an example of homography matrices calculated in S250.

FIGS. 9A, 9B and 9C show an example of calculation equations of an abnormality indicator value Ad.

FIG. 10 is a flowchart showing an example of an abnormal block detection process.

FIG. 11 shows an example of a result image displayed on a display 140.

FIGS. 12A, 12B, 12C, 12D, 12E and 12F are diagrams showing a plurality of block images.

FIGS. 13A, 13B, 13C, 13D, 13E and 13F are diagrams showing a plurality of block images.

FIG. 13G shows an example of a result image displayed on the display 140.

FIG. 14A is a part of a flowchart of an inspection process.

FIG. 14B shows an example of calculation equations for an approximate angle AG and an approximate scale factor SC.

FIG. 15 is a flowchart showing an inspection process.

FIG. 16 is a diagram showing an example of a captured image for the inspection process.

### DESCRIPTION

### A. First Embodiment

### A1. Apparatus Configuration:

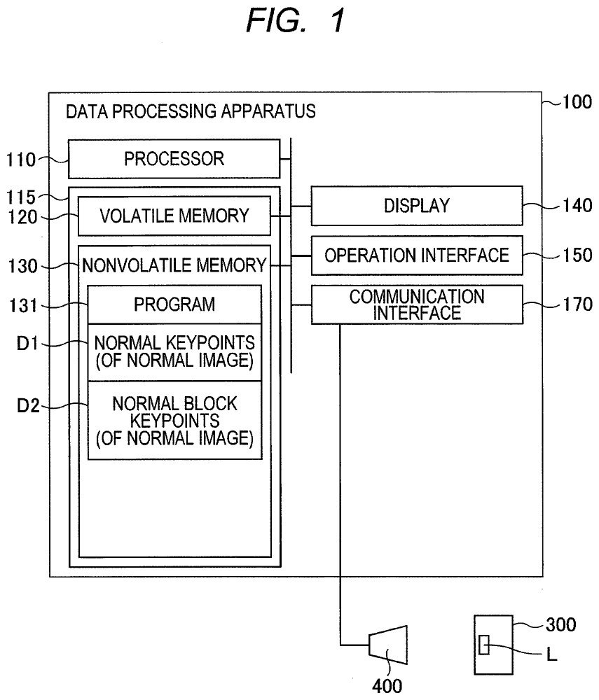

FIG. 1 is an explanatory diagram showing a data processing apparatus as an embodiment. A data processing apparatus 100 is, for example, a personal computer. In the present embodiment, a label L is affixed to a product 300 (for example, a multifunction peripheral). The data processing apparatus 100 processes image data representing a visual of the label L for inspection of the visual of the label L. The data processing apparatus 100 is an example of an image processing apparatus that processes image data representing the visual of an object (the label L in the present embodiment).

The data processing apparatus 100 includes a processor 110, a memory 115, a display 140, an operation interface 150, and a communication interface 170. These elements are connected to each other via a bus. The memory 115 includes a volatile memory 120 and a nonvolatile memory 130.

The processor 110 is a device configured to process data. The processor 110 may be, for example, a CPU (Central Processing Unit) or a SoC (System on a chip). The volatile memory 120 is, for example, a DRAM. The nonvolatile memory 130 is, for example, a flash memory. The nonvolatile memory 130 stores a program 131, normal keypoints D1, and normal block keypoints D2. The details of these data will be described later.

The display 140 is a device configured to display an image, such as a liquid crystal display or an organic EL display. The operation interface 150 is a device configured to receive an operation by a user, such as a button, a lever, or a touch panel overlaid on the display 140. The user inputs various instructions to the data processing apparatus 100 by operating the operation interface 150. The communication interface 170 is an interface for communicating with other apparatuses. The communication interface 170 includes, for example, one or more of a USB interface, a wired LAN interface, an IEEE 802.11 wireless interface, and an industrial camera interface (for example, CameraLink, CoaXPress). A capturing device (camera) 400 is connected to the communication interface 170.

The capturing device 400 generates data of a two-dimensional captured image representing a subject by capturing (shooting) the subject using a two-dimensional image sensor (hereinafter, the two-dimensional captured image is also simply referred to as a “captured image”). In the present embodiment, the capturing device 400 is a so-called digital camera. The captured image data is bitmap data representing an image including a plurality of pixels. In the present embodiment, the captured image data is RGB image data representing the color of each pixel by the gradation values of three color components of red R, green G, and blue B. The R value, the G value, and the B value are represented by, for example, 256 gradations from 0 to 255. The captured image data may represent the color of each pixel by the gradation value of another color component (for example, luminance). The capturing device 400 captures the product 300 to which the label L is affixed, and generates captured image data representing a captured image of a portion of the product 300 including the label L.

### A2. Label and Captured Image:

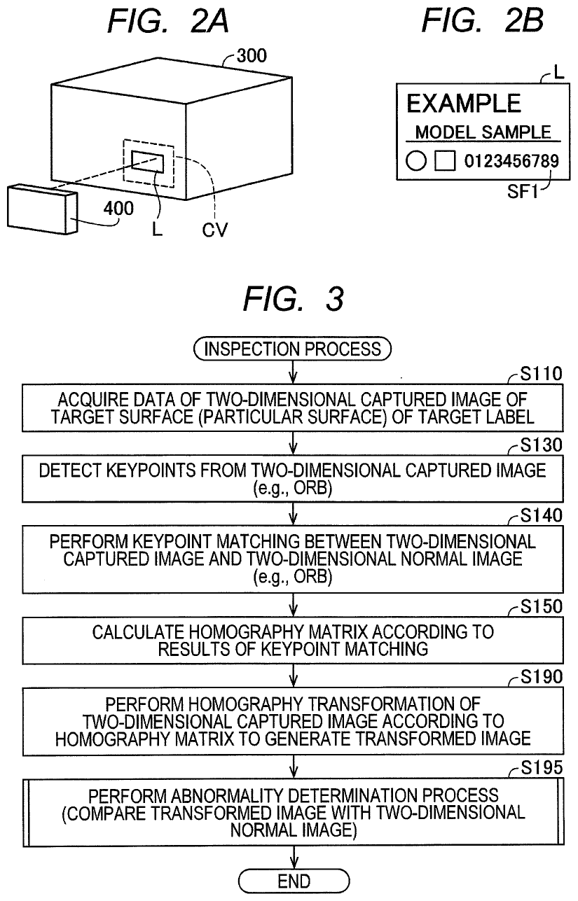

FIG. 2A is a perspective view of the product 300. In the present embodiment, the product 300 is a multifunction peripheral. In the manufacturing process of the product 300, the label L is affixed to a particular position on an outer surface of the product 300. The capturing device 400 captures the label L on the product 300 to inspect the visual of the label L. When the label L is captured, the relative position and orientation of the capturing device 400 with respect to the product 300 are adjusted such that the label L is located within a capturing range CV of the capturing device 400.

FIG. 2B is a diagram showing an example of the label L. In the present embodiment, the label L is a rectangular sheet. A front surface SF1 (also referred to as a particular surface SF1) of the label L may represent various information such as a manufacturer name, a manufacturer logo, a brand logo, a certification mark, and so on. Appropriate information to be represented by the label L is associated with the product 300 in advance. The particular surface SF1 in FIG. 2B represents a particular surface having no abnormality. Although not shown, an adhesive is applied to the back surface of the label L. The shape of the label L may be various other shapes (for example, a circular shape, an elliptical shape, a polygonal shape, and so on) instead of the rectangular shape.

### A3. Inspection Process:

FIG. 3 is a flowchart showing an example of an inspection process. The processor 110 of the data processing apparatus 100 (FIG. 1) performs the inspection process by executing the program 131. As described with reference to FIG. 2A, the relative arrangement between the product 300 and the capturing device 400 is adjusted for inspection. In the present embodiment, the position and orientation of the product 300 are adjusted by a machine (a belt conveyor, a turntable, and so on). After the product 300 is placed, an instruction to start the inspection process is input to the data processing apparatus 100. In the present embodiment, the operator inputs a start instruction by operating the operation interface 150. The processor 110 starts the inspection process in response to the start instruction. The arrangement of the product 300 may be adjusted by the operator. Instead of adjusting the position and the orientation of the product 300, the position and the orientation of the capturing device 400 may be adjusted. The start instruction may be input to the data processing apparatus 100 via the communication interface 170 by another apparatus different from the data processing apparatus 100. The process of FIG. 3 shows the inspection process of one product 300. The processor 110 repeats the process of FIG. 3 to inspect each of a plurality of products 300.

In S110, the processor 110 acquires data of a two-dimensional captured image of a particular surface of a target label which is a label of a processing target. In the present embodiment, the processor 110 supplies a capturing instruction to the capturing device 400. The capturing device 400 captures a portion including the label L of the product 300 in response to the capturing instruction, and generates data of the captured image. The processor 110 acquires the data of the captured image from the capturing device 400.

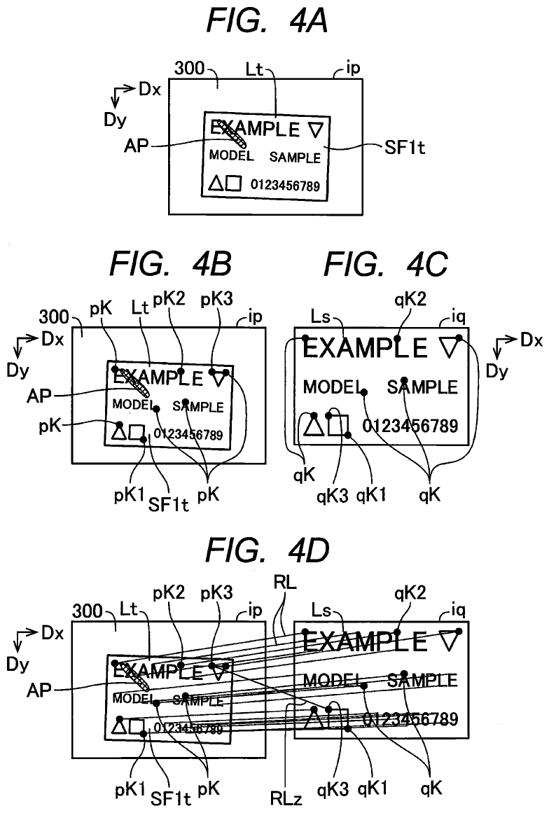

FIG. 4A is a diagram showing an example of a captured image. A captured image (shot image) ip is a rectangular image having two sides parallel to a first direction Dx and two sides parallel to a second direction Dy. The captured image ip is represented by color values (in the embodiment, gradation values of R, G, and B) of each of a plurality of pixels arranged in a matrix along the first direction Dx and the second direction Dy. The captured image ip represents a portion of the product 300 including a target label Lt. The captured image ip represents a particular surface SF1t of the target label Lt (also referred to as a target surface SF1t). The target surface SF1t may include various abnormal portions such as a scratch portion, a dirty portion, and an erroneous information portion (for example, a wrong character), unlike the particular surface SF1 (FIG. 2B) having no abnormality. The target surface SF1t of FIG. 4A includes an abnormal portion AP (here, a dirty portion).

In S130 (FIG. 3), the processor 110 detects keypoints from the captured image by analyzing the captured image. A keypoint is a point that is expected to be likely unique in an image. For example, a point indicating a characteristic portion in the image is detected as a keypoint. Such keypoints are used for image tracking and comparison.

FIG. 4B is a diagram showing an example of keypoints detected from the captured image ip. A plurality of black dots pK in the figure indicate detected keypoints (referred to as “capture keypoints pK” or simply “keypoints pK”). As shown in the figure, a point indicating a characteristic portion such as a corner or an end of a subject (for example, a character, a mark, and so on) is detected as the keypoint pK. In the figure, three keypoints pK1 to pK3 are given individual reference signs for the purpose of the description below. Although not shown, more keypoints pK are detected in practice (for example, about several tens or several hundreds).

The method of detecting keypoints may be various methods. The detection method may be selected in advance from, for example, a search for extreme values (local maximum and local minimum) using a DoG (Difference-of-Gaussian), Harris corner detection, and FAST (Features from Accelerated Segment Test) corner detection. Further, an algorithm for detecting a keypoint and calculating a feature descriptor may be employed for detecting a keypoint. The feature descriptor is information describing the feature of the keypoint. An algorithm for detecting the keypoint and calculating the feature descriptor may be selected in advance from, for example, SIFT (Scale Invariant Feature Transform), SURF (Speeded Up Robust Features), and ORB (Oriented FAST and Rotated BRIEF). In the present embodiment, the processor 110 detects keypoints according to the algorithm of the ORB. For example, a function “detect” or a function “detectAndCompute” of OpenCV (Open Source Computer Vision Library) may be used for detecting keypoints by the ORB algorithm.

In S140, the processor 110 performs keypoint matching between the two-dimensional captured image and a two-dimensional normal image (hereinafter, the two-dimensional normal image is also simply referred to as a “normal image”). FIG. 4C is a diagram showing an example of a normal image. A normal image iq is an image of a normal label Ls which is a label without abnormality. The normal image iq may be various images representing the normal label Ls. In the present embodiment, in the manufacturing process of the product 300, an artwork image is printed on a sheet to form the label L. This artwork image is used as the normal image iq.

In the embodiment, the normal image iq is a rectangular image having two sides parallel to the first direction Dx and two sides parallel to the second direction Dy, similarly to the captured image ip (FIG. 4B). The normal image iq is represented by color values (in the embodiment, gradation values of R, G, and B) of each of a plurality of pixels arranged in a matrix along the first direction Dx and the second direction Dy. The number of pixels in the first direction Dx of the normal image iq may be different from the number of pixels in the first direction Dx of the captured image ip. The number of pixels in the second direction Dy of the normal image iq may be different from the number of pixels in the second direction Dy of the captured image ip.

FIG. 4C shows an example of keypoints detected from the normal image iq. A plurality of black dots qK in the figure indicate keypoints to be detected (referred to as “normal keypoints qK” or simply “keypoints qK”). In the figure, three keypoints qK1 to qK3 are given individual reference signs for the purpose of the description below. Although not shown, more keypoints qK are detected in practice (for example, about several tens or several hundreds).

In this example, the plurality of normal keypoints qK are detected in advance by the same method as the detection method in S130. The data of the normal keypoints D1 (FIG. 1) represents a plurality of detected normal keypoints qK. The data of the normal keypoints D1 are stored in the memory 115 (the nonvolatile memory 130 in the present embodiment) in advance. The processor 110 acquire the plurality of normal keypoints qK by referring to the data of the normal keypoints D1.

In S140, the processor 110 performs matching between the plurality of capture keypoints pK and the plurality of normal keypoints qK. The capture keypoint pK and the normal keypoint qK indicating the same portion of the same subject (for example, the same corner of the same character) are associated with each other by the keypoint matching. The processor 110 extracts a plurality of pairs of keypoints pK and qK associated with each other. Hereinafter, a pair of keypoints pK and qK associated with each other is also referred to as a matching pair.

FIG. 4D shows an example of a result of the keypoint matching. A plurality of lines RL in the figure indicate appropriate matching pairs. Each line RL connects the keypoints pK and qK forming a matching pair. The pair of keypoints pK1 and qK1 indicates the same corner of the same square mark. The pair of keypoints pK2 and qK2 indicate the same end of the same “L” character. A line RLz indicates an inappropriate matching pair. The pair of keypoints pK3 and qK3 indicated by the line RLz indicate different marks. In this way, the result of the keypoint matching may include errors.

The method of keypoint matching may be various methods. For example, the processor 110 may perform keypoint matching by using the feature descriptors of the keypoints. The feature descriptor may be various information describing the feature of the keypoint. For example, the feature descriptor is calculated so as to vary according to the distribution of the color values of a plurality of pixels around the keypoint. The feature descriptor may be calculated by various methods. The algorithm for calculating the feature descriptor may be selected in advance from, for example, BRIEF (Binary Robust Independent Elementary Features), BRISK (Binary Robust Invariant Scalable Keypoints), SIFT, SURF, and ORB. In the present embodiment, the processor 110 uses the feature descriptor based on the ORB algorithm.

In S140, the processor 110 calculates a feature descriptor for each of the capture keypoints pK by analyzing data of the captured image. For example, the function “compute” of OpenCV may be used for the calculation of the feature descriptor based on the algorithm of ORB. Note that in S130 the processor 110 may detect keypoints and calculate feature descriptors. For example, the processor 110 may acquire a plurality of keypoints and the feature descriptor of each of the keypoints by executing the function “detectAndCompute” of OpenCV In this case, in S140, the processor 110 uses the feature descriptor calculated in S130.

In this embodiment, the feature descriptor of each normal keypoint qK is calculated in advance by the same method as the calculation method of the feature descriptor of the keypoint pK. The data of the normal keypoints D1 (FIG. 1) represent a plurality of normal keypoints qK and the feature descriptor of each normal keypoint qK. The data of the normal keypoints D1 are stored in the memory 115 (the nonvolatile memory 130 in the present embodiment) in advance. The processor 110 refers to the data of the normal keypoints D1 to acquire the feature descriptor of each normal keypoint qK.

The method of keypoint matching using feature descriptors may be various methods. The matching method may be selected in advance from, for example, matching based on FLANN (Fast Library for Approximate Nearest Neighbor) and brute-force matching. For example, matching by “cv2.FlannBasedMatcher” of OpenCV may be used for the FLANN based matching. For example, matching by “cv2.BFMatcher” of OpenCV may be used for the brute-force matching. In the present embodiment, the processor 110 performs the brute-force matching.

In the brute-force matching, the processor 110 associates the normal keypoint qK having the shortest distance to a focused keypoint pK, among the plurality of normal keypoints qK, with the focused keypoint pK. The distance between the two keypoints pK and qK is calculated by using the two feature descriptors of the two keypoints pK and qK. This distance is calculated such that a small distance indicates a high degree of similarity between the two feature descriptors. The method of calculating this distance may be any of various methods suitable for the data structure of the feature descriptor. When the feature descriptor is represented by a binary vector (a vector constituted by one or more binary elements), as in the feature descriptors of ORB, BRIEF, and BRISK, the processor 110 may use a Hamming distance. The processor 110 may use various other distances (for example, norms such as L1 norm and L2 norm (also referred to as Euclidean distance)) instead of the Hamming distance. The norm is applicable to various feature descriptors. In the present embodiment, the processor 110 uses the Hamming distance as the distance of the feature descriptor of the ORB. The processor 110 associates each capture keypoint pK with the normal keypoint qK having the shortest distance, by means of the brute-force matching.

Here, the processor 110 may perform a process of excluding pairs having low reliability. For example, the processor 110 may sort the pairs of the keypoints pK and qK in ascending order of distance, and select some of the pairs (for example, 15% of the pairs) in the top order as the final pairs. The processor 110 may also perform a cross-check of the matching. There is a case where the matching result of the capture keypoint pK of the number u is the normal keypoint qK of the number v, but the matching result of the normal keypoint qK of the number v is different from the capture keypoint pK of the number u. In this way, when the matching results are not consistent between a pair of keypoints pK and qK, the cross-check removes the pair.

In S150 (FIG. 3), the processor 110 calculates a homography matrix according to the results of the keypoint matching. The homography matrix is a matrix that represents homography (also called projective transformation). Homography indicates the mapping between two projection planes of the same scene. By homography, straight lines are transformed into straight lines and quadrangles are transformed into quadrangles. A rectangle may be transformed into a trapezoid.

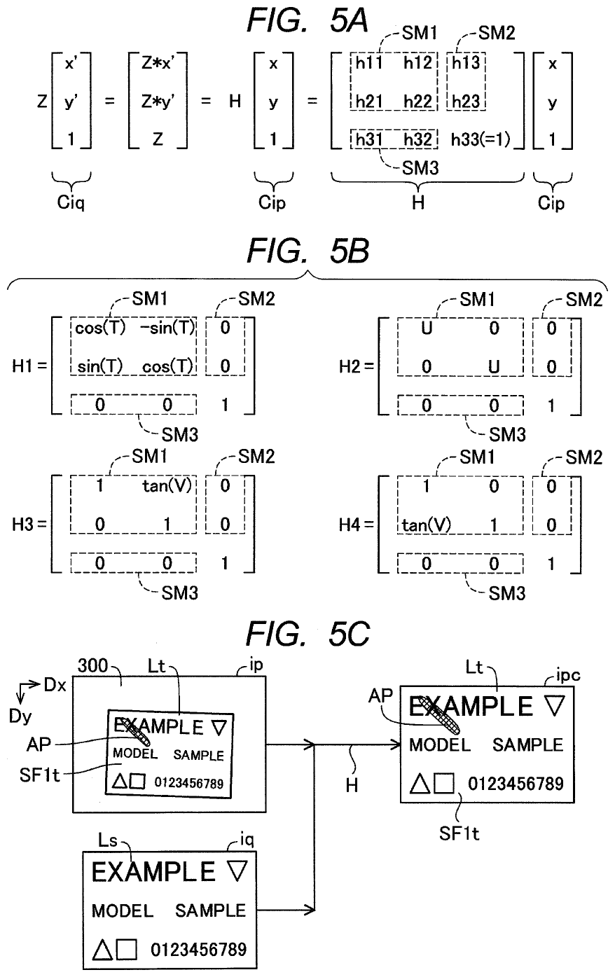

FIG. 5A shows an example of a homography matrix. A homography matrix H represents a correspondence between a position Cip of a point on the captured image ip and a position Ciq of a point on the normal image iq. In the figure, the positions Cip and Ciq are represented by so-called homogeneous coordinates (also called projective coordinates). Two coordinates x and y of the position Cip indicate the position (for example, pixel position) in two directions Dx and Dy perpendicular to each other on the captured image ip (FIG. 4A). These coordinates x, y indicate coordinates in a two-dimensional Cartesian coordinate system representing the position of a point on the captured image ip. The third coordinate of the position Cip is fixed to 1. The same applies to the position Ciq. Two coordinates x′ and y′ of the position Ciq indicate the positions in two directions Dx and Dy perpendicular to each other on the normal image iq (FIG. 4C). These coordinates x′, y′ indicate coordinates in a two-dimensional Cartesian coordinate system representing the position of a point on the normal image iq. By multiplying the coordinates (x, y, 1) of the position Cip by the homography matrix H, the coordinates (Z*x′, Z*y′, Z) are obtained (“*” is a multiplication symbol). The coordinates x′ and y′ are obtained by dividing first and second components (Z*x′, Z*y′) by a third component Z.

The homography matrix H represents the correspondence between two positions Cip and Ciq expressed in homogeneous coordinates. The homography matrix H is represented by a matrix of three rows and three columns. The element hij indicates an element of the i-th row and the j-th column. The lowest right element h33 is fixed to 1. Thus, the homography matrix H has eight degrees of freedom. The remaining eight elements are divided into three submatrices SM1, SM2, and SM3. The first submatrix SM1 is a submatrix composed of four elements h11, h12, h21, and h22. The second submatrix SM2 is a submatrix composed of two elements h13 and h23. The third submatrix SM3 is a submatrix composed of two elements h31 and h32.

The four elements h11, h12, h21, and h22 of the first sub-matrix SM1 represent a coordinate transformation including rotation, scaling (enlargement or reduction) and skew (skew may convert a rectangle into a parallelogram). This coordinate transformation is coordinate transformation between a two-dimensional coordinate system indicating positions on the captured image ip (that is, a two-dimensional coordinate system indicating coordinates x and y) and a two-dimensional coordinate system indicating positions on the normal image iq (that is, a two-dimensional coordinate system indicating coordinates x′ and y′).

FIG. 5B shows an example of homography matrices representing a coordinate transformation. In the figure, four homography matrices H1 to H4 are shown. In these homography matrices H1 to H4, the elements of the sub-matrices SM2, SM3 are zero.

The first homography matrix H1 represents a rotation of an angle T. Here, h11=h22=cos(T), h12=−sin(T), and h21=sin(T).

The second homography matrix H2 represents scaling by a scale factor U. In the second homography matrix H2, h11=h22=U and h12=h21=0. The scale factor may be different between the x-axis and the y-axis. That is, h11 indicates the scale factor of the x-axis, and h22 indicates the scale factor of the y-axis.

The homography matrices H3 and H4 represent skew of an angle V. In the third homography matrix H3, h12=tan (V), h11=h22=1, and h21=zero. The third homography matrix H3 tilts the y-axis by an angle V. The fourth homography matrix H4 is a matrix obtained by exchanging h12 and h21 of the third homography matrix H3. The fourth homography matrix H4 tilts the x-axis by an angle V.

The first submatrix SM1 of the homography matrix H (FIG. 5A) may be decomposed into a product of a plurality of matrices (for example, the first sub-matrices SM1 of the homography matrices H1, H2, H3, H4) that respectively represent a plurality of types of coordinate transformations including rotation, scaling, and skew.

The two elements h13 and h23 of the second submatrix SM2 (FIG. 5A) indicate translation between a two-dimensional coordinate system indicating coordinates x, y and a two-dimensional coordinate system indicating coordinates x′, y′. The two elements h31 and h32 of the third submatrix SM3 change the component Z in accordance with the coordinates x, y. The elements h31 and h32 may transform a rectangle into a trapezoid.

The eight elements h11 to h13, h21 to h23, h31, and h32 of the homography matrix H are determined by using four or more correspondences of the positions Cip and Ciq. For example, the homography matrix H may be determined by using four matching pairs of keypoints pK and qK (FIG. 4B).

The coordinates of each of the keypoints pK and qK (FIG. 4B) of the matching pair may include an error. For example, the position of the capture keypoint pK on the target label Lt may be deviated from the position of the normal keypoint qK associated with the capture keypoint pK on the normal label Ls. In order to mitigate the influence of such an error, in the present embodiment, the processor 110 calculates the eight elements of the homography matrix H by using a number of matching pairs greater than four.

The homography matrix H may be calculated in various methods. The homography matrix H may be calculated by, for example, a simple least squares method or a robust method.

In the least squares method, the homography matrix H is calculated such that the sum of the squares of errors is minimized. Here, the sum of the squares of the errors in position in the first direction Dx and the squares of the errors in position in the second direction Dy may be used as the sum of squares of the errors. The difference in the positions indicate the difference in position between a transformed point obtained by transforming the capture keypoint pK by the homography matrix H and the normal keypoint qK associated with the capture keypoint pK. From a set of matching pair, the square of the Euclidean distance between the transformed point and the normal keypoint qK is calculated. The sum of squares of errors may be the sum of squares of a plurality of distances calculated from a plurality of matching pairs. In the present embodiment, all of the plurality of matching pairs are used for the calculation of the sum of squares of the errors. Alternatively, some matching pairs having small distances of feature descriptors may be used.

The robust method may be various methods that mitigate the effects of inappropriate matching pairs. As the robust method, for example, a method based on RANSAC (Random sample consensus) may be adopted. In the RANSAC-based method, four matching pairs are randomly selected. By using the four matching pairs, a candidate for the homography matrix H is calculated. The method of calculating the candidate of the homography matrix H may be, for example, the least squares method. A plurality of capture keypoints pK are transformed according to the candidate of the homography matrix H. An error (for example, Euclidean distance) between the transformed point and the normal keypoint qK is calculated for each of the plurality of matching pairs. A score indicating the quality of the candidate homography matrix H is calculated by using a plurality of errors of the plurality of matching pairs. The score may be, for example, the total number of matching pairs (also referred to as “inlier”) having an error less than or equal to a particular threshold. The process including the selection of four matching pairs, the calculation of the candidate of the homography matrix H, and the calculation of the score is performed a plurality of times. The candidate with the highest score among the plurality of candidates of the homography matrix H is adopted as the homography matrix H.

In the present embodiment, the processor 110 calculates the homography matrix H according to a method based on RANSAC. For example, the OpenCV function “cv2.findHomography” may be used for the calculation of the homography matrix H based on RANSAC. In this function, various algorithms different from RANSAC are usable depending on the setting of the flag. For example, a simple least squares method may be selected. As the robust method, LMedS (least-median of squares) or RHO may be selected instead of RANSAC. The algorithm for calculating the homography matrix H may be selected from these algorithms instead of RANSAC.

In S190 (FIG. 3), the processor 110 performs a homography transformation of the captured image according to the homography matrix to generate data of a transformed image. FIG. 5C shows an example of the transformed image. A transformed image ipc in the figure indicates an example of an image generated by the homography transformation of the captured image ip. The homography matrix H calculated using the captured image ip and the normal image iq is used for the homography transformation. As illustrated, the position, orientation, and size of the target label Lt in the transformed image ipc are substantially the same as the position, orientation, and size of the normal label Ls in the normal image iq. In the figure, a portion of the transformed image ipc outside the target label Lt is not shown. For example, the OpenCV function “cv2.warpPerspective” may be used for the homography transformation.

In S195 (FIG. 3), the processor 110 performs an abnormality determination process. In this process, the processor 110 determines the presence or absence of an abnormality by comparing the transformed image with the normal image.

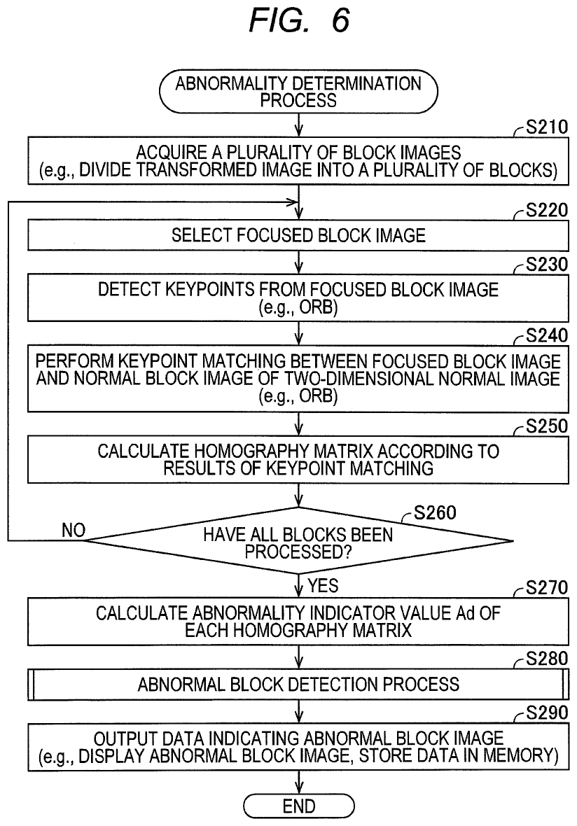

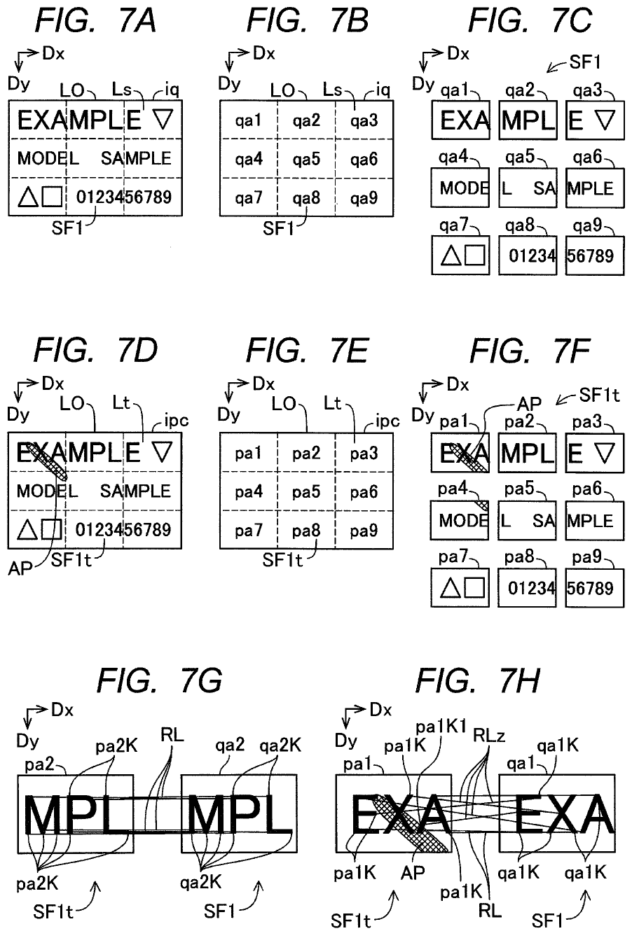

FIG. 6 is a flowchart showing an example of the abnormality determination process. In S210, the processor 110 acquires data of each of a plurality of block images from data of the transformed image. FIGS. 7A to 7F are explanatory diagrams of a plurality of block images. In the present embodiment, the position, size, and shape of each of the plurality of block images are determined in advance by dividing the normal image iq into a plurality of blocks. FIG. 7A shows the normal image iq, and FIG. 7B shows a plurality of block images qa1 to qa9 included in the normal image iq (the contents of the block images are not shown). In the present embodiment, the normal image iq is divided into three equal parts in the first direction Dx and three equal parts in the second direction Dy, and thus is divided into nine block images qa1 to qa9. FIG. 7C shows the content of each of the block images qa1 to qa9 obtained from the normal image iq of FIG. 7A. The block images qa1 to qa9 represent different portions of the particular surface SF1 of the normal label Ls. Hereinafter, the block images qa1 to qa9 of the normal image iq are referred to as normal block images qa1 to qa9.

FIG. 7D represents the transformed image ipc. In the transformed image ipc, an outline LO is shown. The outline LO is obtained by superimposing the outline LO of the normal label Ls on the normal image iq (FIG. 7A) onto the transformed image ipc (hereinafter, the outline LO is referred to as a normal outline LO). The position of the normal outline LO on the transformed image ipc is the same as the position of the normal outline LO on the normal image iq. The normal outline LO substantially matches the outline of the target label Lt.

FIG. 7E shows a plurality of block images pa1 to pa9 included in the transformed image ipc (the contents of the block images are not shown). Hereinafter, the block images pa1 to pa9 of the transformed image ipc are referred to as target block images pa1 to pa9. The target block images pa1 to pa9 are associated with the normal block images qa1 to qa9 of the normal image iq (FIG. 7B), respectively. The target block image and the normal block image associated with each other have the same position, size, and shape with respect to the normal outline LO. For example, the position, size, and shape of the first target block image pa1 with respect to the normal outline LO are the same as the position, size, and shape of the first normal block image qa1 with respect to the normal outline LO, respectively.

FIG. 7F represents the content of each of the target block images pa1 to pa9 obtained from the transformed image ipc of FIG. 7D. The target block images pa1 to pa9 represent different portions of the target surface SF1t of the target label Lt. As described with reference to FIG. 5C, the position, orientation, and size of the target label Lt in the transformed image ipc are substantially the same as the position, orientation, and size of the normal label Ls in the normal image iq, respectively. Thus, the target block image and the normal block image associated with each other represent substantially the same portions of the target surfaces SF1t and SF1 of the labels Lt and Ls. For example, the portion of the target surface SF1t of the target label Lt represented by the first target block image pa1 is substantially the same as the portion of the particular surface SF1 of the normal label Ls represented by the first normal block image qa1 (FIG. 7C). The first target block image pa1 further represents the abnormal portion AP.

In S210 (FIG. 6), the processor 110 acquires data of the target block images pa1 to pa9 by dividing the portion of the transformed image ipc (FIG. 7E) corresponding to the target block images pa1 to pa9.

In S220, the processor 110 selects an unprocessed target block image from the plurality of target block images pa1 to pa9 as a focused block image which is a block image of a processing target.

In S230, the processor 110 detects keypoints from the focused block image by analyzing data of the focused block image. The method of detecting keypoints is the same as that of S130 (FIG. 3). In the present embodiment, the processor 110 acquires a plurality of keypoints and the feature descriptor of each keypoint according to the algorithm of ORB.

In S240, the processor 110 performs keypoint matching between the focused block image and the normal block image associated with the focused block image. The method of the keypoint matching is the same as that of S140 (FIG. 3). In the present embodiment, the processor 110 performs the keypoint matching by using the feature descriptor of each of the plurality of keypoints of the focused block image and the feature descriptor of each of the plurality of keypoints of the normal block image.

In the present embodiment, the plurality of keypoints of each of the normal block images qa1 to qa9 (FIG. 7B) and the feature descriptor of each keypoint have been acquired in advance by the same method as that of S230. Data of the normal block keypoints D2 (FIG. 1) represent a plurality of keypoints of each of the normal block images qa1 to qa9 and the feature descriptor of each keypoint. The data of the normal block keypoints D2 are stored in advance in the memory 115 (in the present embodiment, the nonvolatile memory 130). The processor 110 refers to the data of the normal block keypoints D2 to acquire a plurality of keypoints and the feature descriptor of each keypoint.

FIGS. 7G and 7H are diagrams showing examples of results of the keypoint matching. FIG. 7G shows a case where the focused block image is the second target block image pa2. The processor 110 performs matching between a plurality of keypoints pa2K of the second target block image pa2 and a plurality of keypoints ga2K of the second normal block image qa2. Each of a plurality of lines RL in the figure indicates an appropriate matching pair.

FIG. 7H shows a case where the focused block image is the first target block image pa1. In S230 (FIG. 6), a plurality of keypoints pa1K are detected from the first target block image pa1. The first target block image pa1 includes the abnormal portion AP. The abnormal portion AP may alter an original characteristic portion of the target surface SF1t. For example, in the first target block image pa1 of FIG. 7H, a part of the character “X” is hidden by the abnormal portion AP. As a result, a keypoint indicating a characteristic portion of the character “X” may not be detected. Further, the abnormal portion AP may form a new characteristic portion which does not exist on the original target surface SF1t. For example, in the first target block image pa1, the abnormal portion AP overlaps a part of the character “A”. From this overlapping part, a new keypoint (for example, a keypoint pa1K1) may be detected. In this way, a keypoint that should not be detected may be detected due to the abnormal portion AP.

The processor 110 performs matching between the plurality of keypoints pa1K of the first target block image pa1 and the plurality of keypoints ga1K of the first normal block image qa1. Each of the plurality of lines RL in the figure indicates an appropriate matching pair. Each of a plurality of lines RLz in the figure indicates an inappropriate matching pair. The possibility of forming an inappropriate matching pair increases due to the abnormal portion AP.

Thus, when the focused block image includes an abnormal portion (for example, FIG. 7H), the ratio of the total number of inappropriate matching pairs to the total number of the plurality of matching pairs is likely to be higher than when the focused block image does not include an abnormal portion (for example, FIG. 7G).

In S250 (FIG. 6), the processor 110 calculates the homography matrix of the focused block image according to the result of the keypoint matching. The method of calculating the homography matrix is the same as the method of S150 (FIG. 3).

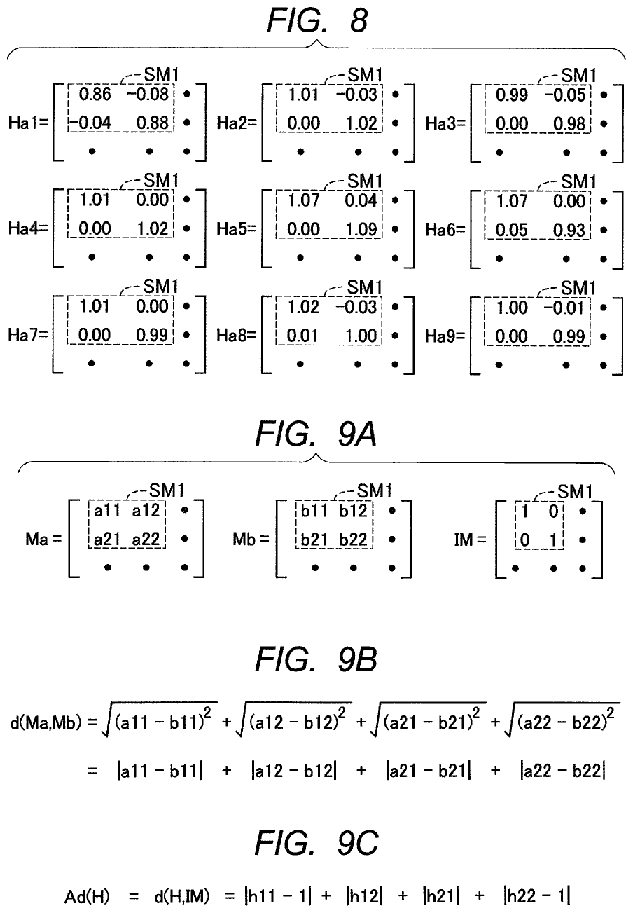

FIG. 8 shows an example of the homography matrix calculated in S250. Nine homography matrices Ha1 to Ha9 correspond to the nine target block images pa1 to pa9, respectively. The homography matrices Ha1 to Ha9 indicate a correspondence between a position on the target block images pa1 to pa9 (FIG. 7F) and a position on the corresponding normal block images qa1 to qa9 (FIG. 7C). In the figure, four elements of the first submatrix SM1 (FIG. 5A) among nine elements of the homography matrix are shown. As described with reference to S190 (FIG. 3) and FIG. 5C, the positions, orientations, and sizes of the labels Ls and Lt are substantially the same between the normal image iq and the transformed image ipc. Between the target block image and the normal block image which are associated with each other, the rotation angle is approximately zero, the scale factor is approximately 1, and the skew angle is approximately zero. Thus, it is expected that the first submatrix SM1 is an identity matrix.

Inappropriate matching pairs may be used for calculation of the homography matrix. Hereinafter, the ratio of the number of inappropriate matching pairs to the number of matching pairs used for calculation of the homography matrix is referred to as an inappropriate pair ratio. As in the second target block image pa2 (FIG. 7G), when the ratio of the abnormal portion in the target block image is small, the inappropriate pair ratio is expected to be smaller than when the ratio of the abnormal portion is large. When the inappropriate pair ratio is small, the difference between the first submatrix SM1 and the identity matrix is smaller than when the inappropriate pair ratio is large. As shown in FIG. 7F, the ratio of the abnormal portion is small in the eight target block images pa2 to pa9 other than the first target block image pa1 (the seven target block images pa2, pa3, pa5 to pa9 do not include an abnormal portion). Each of the eight first submatrices SM1 of the eight homography matrices Ha2 to Ha9 (FIG. 8) corresponding to the eight target block images pa2 to pa9 is close to the identity matrix. Specifically, two diagonal components (elements h11, h22 (FIG. 5A)) are approximately 1, and the other two components (h12, h21 (FIG. 5A)) are approximately zero.

As in the first target block image pa1 (FIG. 7H), when the ratio of the abnormal portion in the target block image is large, the inappropriate pair ratio is expected to be larger than when the ratio of the abnormal portion is small. When the inappropriate pair ratio is large, the difference between the first submatrix SM1 and the identity matrix is larger than when the inappropriate pair ratio is small. The difference between the first submatrix SM1 of the homography matrix Ha1 (FIG. 8) corresponding to the first target block image pa1 and an identity matrix is large. Specifically, the difference between the diagonal components (elements h11, h22 (FIG. 5A)) and 1 is large, and the difference between the other components (h12, h21 (FIG. 5A)) and zero is large.

In S260 (FIG. 6), the processor 110 determines whether all the target block images have been processed. When there is an unprocessed target block image (S260: No), the processor 110 proceeds to S220 and processes a new target block image.

When the processing of all the target block images is completed (S260: Yes), in S270, the processor 110 calculates an abnormality indicator value Ad of the homography matrix of each of all the target block images. FIGS. 9A to 9C show an example of calculation equations of the abnormality indicator value Ad. FIG. 9A shows two matrices Ma and Mb and an identity matrix IM. These matrices Ma, Mb, and IM are matrices of three rows and three columns, similarly to the homography matrix. In the figure, four elements of the first submatrix SM1 are shown. The elements aij and bij of the matrices Ma and Mb indicate the elements of the i-th row and the j-th column, respectively.

FIG. 9B shows an example of a calculation equation of a distance d between the two matrices Ma and Mb. In the present embodiment, the difference d is the sum of the absolute value of the difference between corresponding values of each of the four elements of the first submatrix SM1.

FIG. 9C shows an example of a calculation equation of the abnormality indicator value Ad of the homography matrix H. In the present embodiment, the abnormality indicator value Ad of the homography matrix H indicates a distance d between the homography matrix H and the identity matrix IM. The abnormality indicator value Ad is the sum of the absolute value of the difference between the diagonal components h11 and “1”, the absolute value of the difference between the diagonal components h22 and “1”, and the absolute values of each of the other two components h12 and h21. The abnormality indicator value Ad increases as the deviation between the homography matrix H and the identity matrix IM increases. For example, the abnormality indicator value Ad of the homography matrix Ha1 (FIG. 8) is greater than the abnormality indicator values Ad of the other homography matrices Ha2 to Ha9.

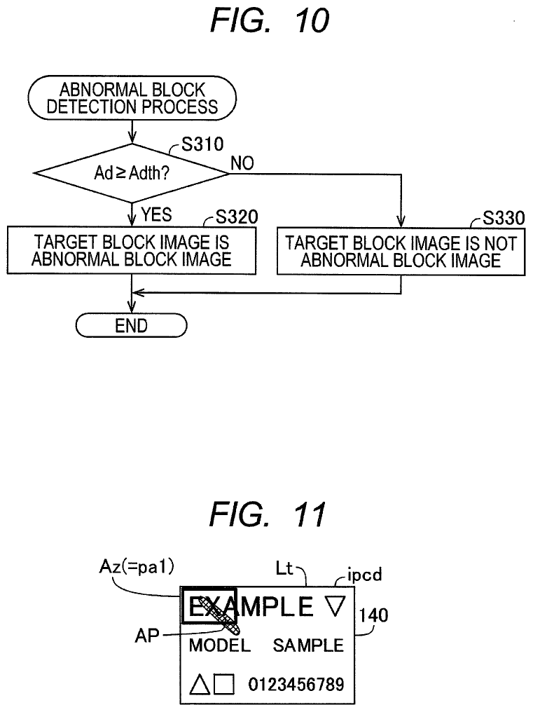

In S280 (FIG. 6), the processor 110 performs an abnormal block detection process. FIG. 10 is a flowchart showing an example of the abnormal block detection process. The process of FIG. 10 shows a process for one target block image. The processor 110 performs the process of FIG. 10 on each of the plurality of target block images pa1 to pa9.

In S310, the processor 110 determines whether the abnormality indicator value Ad of the target block image is greater than or equal to a threshold Adth. When the abnormality indicator value Ad is greater than or equal to the threshold Adth (S310: Yes), in S320 the processor 110 determines that the target block image is an abnormal block image having an abnormal portion, and ends the process of FIG. 10. When the abnormality indicator value Ad is less than the threshold Adth (S310: No), in S330 the processor 110 determines that the target block image is not an abnormal block image, and ends the process of FIG. 10.

The threshold Adth is experimentally determined in advance such that the abnormality indicator value Ad of the target block image including the abnormal portion is greater than or equal to the threshold Adth and the abnormality indicator value Ad of the target block image not including the abnormal portion is less than the threshold Adth. Thus, the abnormality indicator value Ad of the first target block image pa1 (FIG. 7F) including the abnormal portion AP is expected to be greater than or equal to the threshold Adth. The abnormality indicator values Ad of the other target block images pa2 to pa9 is expected to be less than the threshold Adth.

In S290 (FIG. 6), the processor 110 outputs data indicating the abnormal block image. For example, the processor 110 outputs data of a result image representing the transformed image ipc and the abnormal block image on the transformed image ipc to the display 140, thereby causing the display 140 to display the result image. FIG. 11 shows an example of the result image displayed on the display 140. A result image ipcd represents the target label Lt and a mark Az indicating the abnormal block image. In the example of FIG. 11, the mark Az indicates the outline of the abnormal block image (here, the first target block image pa1). The operator easily recognizes the abnormal portion AP indicated by the mark Az by observing the result image ipcd. Further, the processor 110 may output result data indicating the abnormal block image (for example, data indicating the identification number of the abnormal block image) to the memory 115 (for example, the nonvolatile memory 130). That is, the processor 110 may store the result data in the memory. The result data may be used for various processes that refer to the detection result of the abnormal block image. For example, a process of removing the product 300 to which the label having the abnormal portion is affixed from the manufacturing line may be performed with reference to the result data.

After S290 (FIG. 6), the processor 110 ends the process of FIG. 6, that is, the process of S195 of FIG. 3. Then, the process of FIG. 3 ends.

As described above, in the present embodiment, the processor 110 of the data processing apparatus 100 (FIG. 1) performs the following processes. In S110 (FIG. 3), the processor 110 acquires the data of the two-dimensional captured image ip (FIG. 4A). The captured image ip represents the particular surface SF1t of the target label Lt. The target label Lt is an example of a target object that is an object of a processing target. In S130 and S140, the processor 110 performs the keypoint matching between the captured image ip and the normal image iq. The normal image iq represents the normal particular surface SF1 (FIG. 2B). In the present embodiment, the data of the normal keypoints D1 (FIG. 1) representing the keypoints of the normal image iq are prepared in advance. Thus, the process of detecting the keypoints from the normal image iq is omitted. In S150 and S190, the processor 110 generates the data of the transformed image ipc (FIG. 5C) by performing the homography transformation on the captured image ip in accordance with the result of the keypoint matching. The captured image ip is an example of a first image that is an image of the target of homography transformation. The normal image iq is an example of a second image different from the first image (here, the captured image ip) among the captured image ip and the normal image iq.

In S195, the processor 110 performs the abnormality determination process of comparing the normal image iq with the transformed image ipc to determine whether the particular surface SF1t of the target label Lt has an abnormality. In the present embodiment, the process of S195 includes S230, S240, and S250 (FIG. 6). In S230, S240, and S250, the processor 110 calculates the homography matrices Ha1 to Ha9 (FIG. 8) that associates the target block images pa1 to pa9 (FIG. 7F) of the transformed image ipc with the normal block images qa1 to qa9 (FIG. 7C) of the normal image iq. The homography matrices Ha1 to Ha9 vary depending on the difference between the transformed image ipc and the normal image iq. The homography matrices Ha1 to Ha9 are an example of the result of comparison between the transformed image ipc and the normal image iq.

The process of S195 further includes S270 and S280 (FIG. 6). In S270 and S280, the processor 110 determines whether each of the target block images pa1 to pa9 is an abnormal block by using the homography matrices Ha1 to Ha9.

In this way, the processor 110 compares the transformed image ipc obtained by the homography transformation with the normal image iq to determine whether the target surface SF1t of the target label Lt has an abnormality. The homography transformation reduces the influence of the difference in projection planes between the captured image ip and the normal image iq on the determination of abnormality. For example, when the capturing device 400 (FIG. 2A) captures an image of the rectangular target label Lt from an oblique direction, the shape of the target label Lt on the captured image ip may be a shape different from a rectangle (for example, a trapezoid). The difference between the shape of the target label Lt on the captured image ip and the shape of the normal label Ls on the normal image iq may affect the determination of abnormality. In the present embodiment, since the transformed image ipc obtained by the homography transformation and the normal image iq are compared, the influence of the difference in the shapes of the labels Lt and Ls (that is, the difference in the projection planes) between the captured image ip and the normal image iq is reduced.

The homography matrices H, Ha1 to Ha9 are calculated without a high load preparation such as training of a machine learning model. In the present embodiment, the burden of preparation is reduced compared with a case where a machine learning model is used to determine whether the target surface SF It has an abnormality.

In the present embodiment, the process of S195 (FIG. 3) includes S210, S230, S240, S250, S270 and S280 of FIG. 6. In S210, as shown in FIGS. 7D to 7F, the processor 110 acquires N (N=9 in the present embodiment) target block images pa1 to pa9 from the transformed image ipc. The target block image is an example of a first type partial image acquired from the transformed image. The N target block images pa1 to pa9 include different portions of the target surface SF1t represented by the transformed image ipc.

In S230 and S240, the processor 110 performs the keypoint matching of each of N combinations of the target block image and the normal block image which are associated with each other. The normal block images qa1 to qa9 (FIG. 7C) are examples of the second type partial images to be compared with the first type partial images (in the present embodiment, the target block images) by the keypoint matching. The N normal block images qa1 to qa9 forming the N combinations include different portions of the particular surface SF1 represented by the normal image iq. The portion of the particular surface SF1 included in the normal block image includes a portion common to a portion of the target surface SF1t included in the target block image associated with the normal block image. For example, the portion of the particular surface SF1 (FIG. 7C) included in the first normal block image qa1 includes a portion (here, a portion representing the characters “EXA”) common to the portion of the target surface SF1t (FIG. 7F) included in the first target block image pa1.

In S250, the processor 110 calculates the N homography matrices Ha1 to Ha9 (FIG. 8) according to the N results of the keypoint matching. In S270, the processor 110 calculates the abnormality indicator value Ad of each of the N homography matrices Ha1 to Ha9 (FIG. 8). As described with reference to FIGS. 9A to 9C, the abnormality indicator value Ad indicates the degree of difference between the homography matrix and the identity matrix IM.

In S280, the processor 110 determines whether the target block image is an abnormal block image by comparing the abnormality indicator value Ad with the threshold Adth (FIG. 10: S310). This determination is performed for each of the N target block images pa1 to pa9. The determination result that one or more target block images are abnormal block images indicates that the target surface SF1t of the target label Lt has an abnormality. The determination result that all the target block images are not abnormal block images indicates that the target surface SF1t of the target label Lt has no abnormality. In this way, the processor 110 determines whether the target surface SF1t of the target label Lt has an abnormality by using the N homography matrices Ha1 to Ha9.

In this way, the processor 110 appropriately determines whether the target surface SF1t has an abnormality, by comparing the abnormality indicator value Ad indicating the degree of difference between the homography matrices Ha1 to Ha9 and the identity matrix IM with the threshold Adth indicating a reference for the degree of difference.

In the present embodiment, the processor 110 uses the keypoints to determine whether the target surface SF1t has an abnormality. Thus, even when the captured image ip includes blur or noise, appropriate determination is made.

The transformed image ipc (FIG. 5C) is generated by the homography transformation of the captured image ip. The transformed image ipc and the captured image ip represent the same scene (here, the captured target label Lt) (however, the projection plane is different between the transformed image ipc and the captured image ip). Thus, the transformed image ipc is a kind of captured image. Hereinafter, the captured image ip is also referred to as a first type captured image ip, and the transformed image ipc is also referred to as a second type captured image ipc. When the present embodiment is viewed from the viewpoint that the transformed image ipc is a kind of captured image, in the description of the present embodiment, the “transformed image ipc” may be read as (replaced with) a “second type captured image ipc”. The processor 110 performs processes described by such replacement. In S110 to S190 (FIG. 3), the processor 110 acquires data of the second type captured image ipc of the particular surface SF1t of the target label Lt. In S195, the processor 110 performs an abnormality determination process of comparing the second type captured image ipc with the normal image iq to determine whether the particular surface SF1t of the target label Lt has an abnormality.

The process of S195 includes S210, S230, S240, S250, S270 and S280 of FIG. 6. In these steps, N (N=9 in the present embodiment) target block images pa1 to pa9 (FIGS. 7D to 7F) and N normal block images qa1 to qa9 (FIGS. 7A to 7C) are used. The N target block images pa1 to pa9 are examples of the first type partial images acquired from the second type captured image ipc. The N normal block images qa1 to qa9 are examples of the second type partial images to be compared with the first type partial images (in the present embodiment, the target block images) by the keypoint matching.

As described above with reference to S210, S230, S240, S250, S270, and S280, the processor 110 appropriately determines whether the target surface SF1t has an abnormality by comparing the abnormality indicator value Ad indicating the degree of difference between the homography matrices Ha1 to Ha9 and the identity matrix IM with the threshold Adth indicating a reference for the degree of difference. Here, the homography matrices Ha1 to Ha9 are calculated by using the second type captured image ipc and the normal image iq.

Regardless of whether the “transformed image ipc” is replaced with the “second type captured image ipc”, in the present embodiment, the N homography matrices Ha1 to Ha9 (FIG. 8) may be described as follows. Each of the N homography matrices Ha1 to Ha9 includes the first submatrix SM1 formed by elements of two rows and two columns. As described with reference to FIGS. 5A and 5B, the first submatrix SM1 represents the coordinate transformation including the rotation and scaling between the two-dimensional coordinate system before the transformation and the two-dimensional coordinate system after the transformation. That is, the first submatrix SM1 of each of the N homography matrices Ha1 to Ha9 represents coordinate transformation including rotation and scaling between a two-dimensional coordinate system indicating positions on the target block image and a two-dimensional coordinate system indicating positions on the normal block image.

As described in S270 (FIG. 6) and FIGS. 9A to 9C, the abnormality indicator value Ad indicates the degree of difference between the first submatrix SM1 of two rows and two columns and the identity matrix of two rows and two columns. When the ratio of the abnormal portion in the target block image is small as in the second target block image pa2 (FIG. 7G), it is expected that the difference between the first submatrix SM1 and the identity matrix is small. When the ratio of the abnormal portion in the target block image is large as in the first target block image pa1 (FIG. 7H), it is expected that the difference between the first submatrix SM1 and the identity matrix is large. The processor 110 appropriately determines whether the target surface SF1t of the target label Lt has an abnormality by using the abnormality indicator value Ad.

### B. Second Embodiment

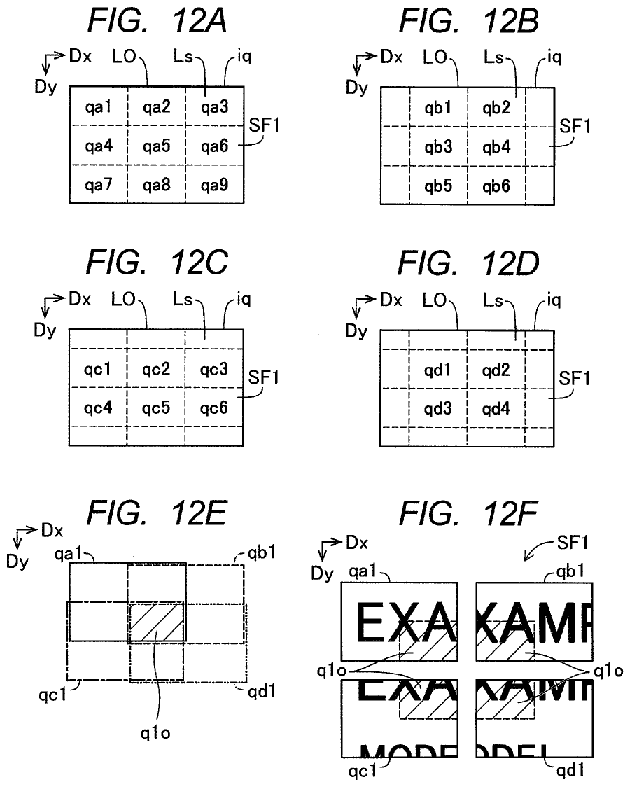

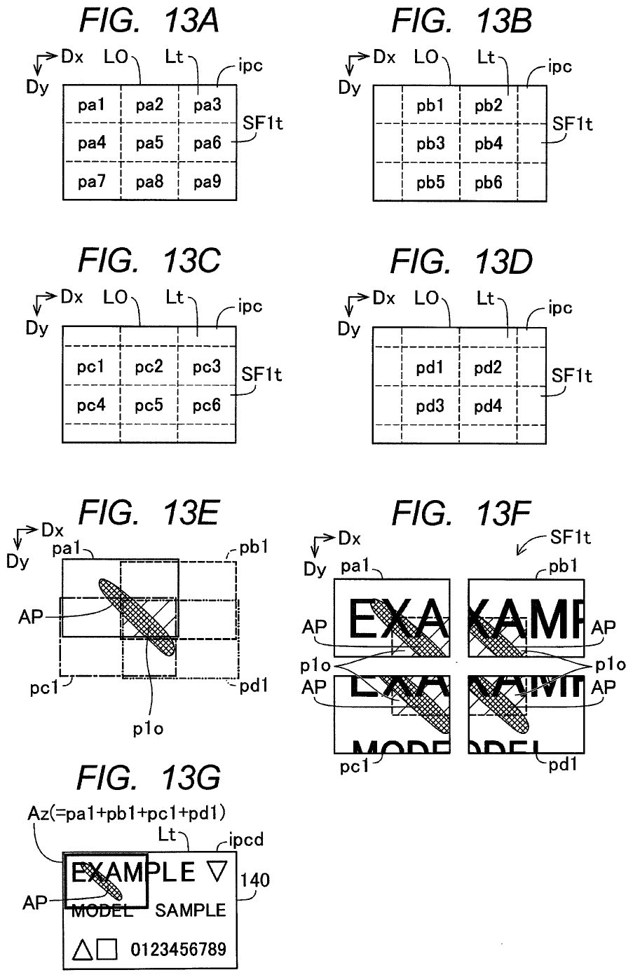

FIGS. 12A to 12F and FIGS. 13A to 13F are diagrams showing another embodiment of a plurality of block images used in the abnormality determination processing of FIG. 6. The difference from the first embodiment of FIGS. 7B and 7E is that the plurality of block images include an overlapping block image that partially overlaps one or more other block images. The abnormality determination process is the same as the abnormality determination process of the first embodiment except that the configurations of the plurality of block images are different.

FIGS. 12A to 12D respectively illustrate a plurality of normal block images qa1 to qa9, qb1 to qb6, qc1 to qc6, and qd1 to qd4 included in the normal image iq (illustrations of the content of the block images are omitted). The normal block images qa1 to qa9 in FIG. 12A are the same as the normal block images qa1 to qa9 in FIG. 7B, respectively. Hereinafter, the normal block images qa1 to qa9 are referred to as first type normal block images qa1 to qa9.

The regions of second type normal block images qb1 to qb6 of FIG. 12B are respectively formed by moving the regions of the first type normal block images qa1, qa2, qa4, qa5, qa7, and qa8 of FIG. 12A in the first direction Dx. The amount of movement is half the length of one block image in the first direction Dx.

The regions of third type normal block images qc1 to qc6 of FIG. 12C are respectively formed by moving the regions of the first type normal block images qa1 to qa6 of FIG. 12A in the second direction Dy. The amount of movement is half the length of one block image in the second direction Dy.

The regions of fourth type normal block images qd1 to qd4 of FIG. 12D are respectively formed by moving the regions of the second type normal block images qb1 to qb4 of FIG. 12B in the second direction Dy. The amount of movement is half the length of one block image in the second direction Dy.

Thus, the shape and size are the same among the first type normal block images, the second type normal block images, the third type normal block images, and the fourth type normal block images. Further, one or both of the positional deviation amount in the first direction Dx and the positional deviation amount in the second direction Dy between the first type normal block images, the second type normal block images, the third type normal block images, and the fourth type normal block images is a value obtained by adding a half of the length of one block image to a multiple of the length of one block image. Thus, one block image partially overlaps one or more other type block images. FIG. 12E shows four types of block images qa1, qb1, qc1, and qd1. These block images qa1, qb1, qc1, and qd1 partially overlap each other. A common portion q1o is common to the block images qa1, qb1, qc1, and qd1.

FIG. 12F shows the content of each of the four types of block images qa1, qb1, qc1, and qd1. The normal block images qa1, qb1, qc1, and qd1 represent different portions of the particular surface SF1. For example, the first type normal block image qa1 includes the characters “EXA” (particularly, the character “E”), and does not include the character “M” following “EXA”. The second type normal block image qb1 does not include the character “E”, but includes the character “XAM” (particularly, the character “M”) following “E”. In this way, the normal block images qa1 and qb1 represent different portions of the particular surface SF1. Other combinations of two normal block images that partially overlap each other also represent different portions of the particular surface SF1.

Although not shown, other normal block images different from the normal block images qa1, qb1, qc1, and qd1 also partially overlap one or more other type normal block images.

FIGS. 13A to 13D respectively show a plurality of target block images pa1 to pa9, pb1 to pb6, pc1 to pc6, and pd1 to pd4 included in the transformed image ipc (illustrations of the contents of the block images are omitted). The target block images pa1 to pa9, pb1 to pb6, pc1 to pc6, and pd1 to pd4 are associated with the normal block images qa1 to qa9, qb1 to qb6, qc1 to qc6, qd1 to qd4 of FIGS. 12A to 12D, respectively. The target block image and the normal block image associated with each other have the same position, size, and shape with respect to the normal outline LO. Hereinafter, the target block images of FIGS. 13A, 13B, 13C, and 13D are referred to as first type target block images, second type target block images, third type target block images, and fourth type target block images, respectively.

FIG. 13E shows four types of block images pa1, pb1, pc1, and pd1. The block images pa1, pb1, pc1, and pd1 partially overlap each other. A common portion p1o is common to the block images pa1, pb1, pc1, and pd1.

FIG. 13F shows the content of each of the four types of block images pa1, pb1, pc1, and pd1. Like the normal block images qa1, qb1, qc1, and qd1 in FIG. 12F, the target block images pa1, pb1, pc1, and pd1 represent different portions of the target surface SF1t.

Although not shown, other target block images different from the target block images pa1, pb1, pc1, and pd1 also partially overlap one or more other type target block images.

As described in FIG. 5C, the position and size of the target label Lt in the transformed image ipc are approximately the same as the position and size of the normal label Ls in the normal image iq, respectively. Thus, the target block image and the normal block image associated with each other represent substantially the same portions of the target surfaces SF1t and SF1 of the labels Lt and Ls. For example, the portion of the target surface SF1t of the target label Lt represented by the target block image pd1 (FIG. 13F) is substantially the same as the portion of the particular surface SF1 of the normal label Ls represented by the normal block image qd1 (FIG. 12F). The target block image pd1 further represents the abnormal portion AP.

In S210 (FIG. 6), the processor 110 acquires the 25 target block images pa1 to pa9, pb1 to pb6, pc1 to pc6, and pd1 to pd4 (FIGS. 13A-13D) from the transformed image ipc. The processor 110 performs the processes of S220 to S260 on each of 25 block image pairs consisting of 25 target block images and 25 normal block images.

A plurality of keypoints of each of the 25 normal block images and the feature descriptor of each keypoint are acquired in advance by the same method as the method of S230. In the present embodiment, data of the normal block keypoints D2 (FIG. 1) represent the plurality of keypoints of each of the 25 normal block images and the feature descriptor of each keypoint. The data of the normal block keypoints D2 are stored in advance in the memory 115 (in the present embodiment, the nonvolatile memory 130).

In S270 (FIG. 6), the processor 110 calculates the abnormality indicator value Ad for each of 25 homography matrices. In S280, the processor 110 performs the process of FIG. 10 on each of the 25 target block images. In S290, the processor 110 outputs data indicating an abnormal block image. FIG. 13G shows an example of a result image displayed on the display 140. The result image ipcd represents the target label Lt and the mark Az indicating the abnormal block image. In the example of FIG. 13G, the mark Az indicates the outline of the abnormal block image (here, the region including the target block images pa1, pb1, pc1, and pd1).

As described above, in the present embodiment, the target block images pa1 to pa9, pb1 to pb6, pc1 to pc6, and pd1 to pd4 are examples of the first type partial image acquired from the transformed image. The normal block images qa1 to qa9, qb1 to qb6, qc1 to qc6, and qd1 to qd4 are examples of the second type partial image to be compared with the first type partial image (in the present embodiment, the target block image) by the keypoint matching.

As described with reference to FIGS. 13A to 13F, each of the N (N=25 in the present embodiment) target block images partially overlaps one or more other target block images. The target block image partially overlapping one or more other target block images is referred to as a first type overlapping partial image. The N target block images may include L first type overlapping partial images (L is an integer greater than or equal to two and less than or equal to N). In the present embodiment, each of the N target block images is an example of the first type overlapping partial image (L=N).

As described with reference to FIGS. 12A to 12D and 13A to 13D, the position, size, and shape of the target block image are the same as the position, size, and shape of the normal block image associated with the target block image. That is, a second type overlapping partial image, which is a normal block image associated with the first type overlapping partial image (in the present embodiment, the target block image), partially overlaps one or more other normal block images (FIGS. 12E and 12F). In the present embodiment, each of the N normal blocks is an example of the second type overlapping partial image.

As shown in FIGS. 12E and 12F, one or more (three in the present embodiment) other normal block images qb1, qc1, and qd1 partially overlap the normal block image qa1. The target block image pa1 of FIG. 13F is associated with the normal block image qa1 of FIG. 12F. One or more (three in the present embodiment) other target block images pb1, pc1, and pd1 partially overlap the target block image pa1. The target block images pb1, pc1, and pd1 partially overlapping the target block image pa1 are respectively associated with the normal block images qb1, qc1, and qd1 partially overlapping the normal block image qa1 (FIG. 12F). In this way, one or more other normal block images (for example, the normal block images qb1, qc1, and qd1) partially overlapping the second type overlapping partial image (for example, the normal block image qa1) are respectively associated with one or more other target block images (for example, the target block images pb1, pc1, and pd1) partially overlapping the first type overlapping partial image (for example, the target block image pa1) associated with the second type overlapping partial image.

Thus, when the target surface SF1t of the target label Lt includes the abnormal portion AP, each of the plurality of target block images may represent a part or all of the abnormal portion AP. The processor 110 may derive a determination result that the target block image has an abnormal portion, from each of the plurality of combinations of the target block image and the normal block image. In this way, the processor 110 appropriately determines whether the target surface SF1t has an abnormal portion. For example, in the embodiment of FIG. 13F, each of the four target block images pa1, pb1, pc1, and pd1 represents a part of the abnormal portion AP. In this case, the processor 110 may derive a determination result that the target block image has an abnormal portion from each of four combinations of the target block image and the normal block image “pa1 and qa1”, “pb1 and qb1”, “pc1 and qc1”, and “pd1 and qd1”. Even if a determination result that the target block image is not an abnormal block image is acquired from one combination “pa1 and qa1”, a determination result that the target block image is an abnormal block image may be acquired from other combinations. Thus, the possibility of missing an abnormal portion is reduced.

When each of the plurality of target block images includes a part or all of the abnormal portion, the processor 110 detects the plurality of target block images as abnormal block images. Thus, as indicated by the mark Az in FIG. 13G, the processor 110 detects a region including the entirety of the abnormal portion.

As described above, the transformed image ipc is a type of the captured image. In this respect, in the description of the present embodiment, the “transformed image ipc” may be read as “second type captured image ipc”. In this case, the target block image (for example, the target block image pa1 (FIG. 13F)) is an example of the first type partial image acquired from the second type captured image ipc. The normal block image (for example, the normal block image qa1 (FIG. 12F)) is an example of the second type partial image to be compared with the first type partial image (in the present embodiment, the target block image) by the keypoint matching. As described above, the processor 110 appropriately determines whether the target surface SF1t has an abnormal portion by using N first type partial images (here, target block images) including L first type overlapping partial images and N second type partial images (here, normal block images) including L second type overlapping partial images.

### C. Third Embodiment

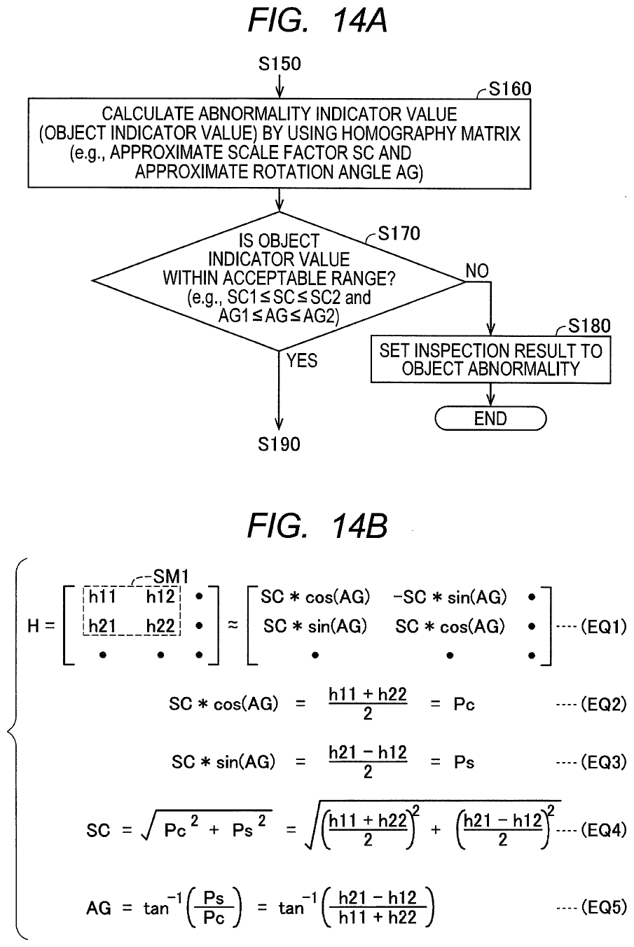

FIG. 14A is a part of a flowchart of another embodiment of the inspection process. The difference from the inspection process of FIG. 3 is that S160, S170, and S180 are inserted between S150 and S190. In the present embodiment, the processor 110 determines whether there is an abnormality related to the target label Lt by using the homography matrix H calculated in S150 before the abnormality determination process (S195).

In S160, the processor 110 uses the homography matrix H to calculate an abnormality indicator value. In S160, the processor 110 calculates an indicator value indicating the possibility of abnormality related to the target label Lt represented by the captured image ip (also referred to as an object indicator value). In the present embodiment, the processor 110 calculates an approximate rotation angle AG that approximates the rotation angle by the homography matrix H and an approximate scaling factor SC that approximates the scale factor by the homography matrix H. Hereinafter, the approximate rotation angle AG is also referred to as an approximate angle AG. The approximate scaling factor SC is also referred to as an approximate scale factor SC.

FIG. 14B shows an example of equations for calculating the approximate angle AG and the approximate scale factor SC. In the figure, five equations EQ1 to EQ5 are shown. The first equation EQ1 indicates a correspondence between the homography matrix H, the approximate angle AG, and the approximate scale factor SC. Here, it is assumed that the first submatrix SM1 of the homography matrix H is represented by the product of a matrix (matrix H1 (FIG. 5B)) indicating the rotation of the approximate angle AG and a matrix (matrix H2 (FIG. 5B)) indicating the scaling of the approximate scale factor SC. That is, it is assumed that the influence of other types of coordinate transformation (for example, skew) is sufficiently small. In this case, as shown in the figure, the elements h11 and h22 are represented by “SC*cos(AG)”, the elements h12 is represented by “−SC*sin(AG)”, and the elements h21 is represented by “SC*sin(AG)”.

In practice, the homography matrix H is affected by various parameters, such as the orientation of the capturing device 400 relative to the label L (FIG. 2A), distortion of a lens (not shown) of the capturing device 400, and so on. The elements h11, h12, h21, and h22 of the first submatrix SM1 may deviate from values calculated only from rotation and scaling. Thus, in the present embodiment, the processor 110 calculates the approximate angle AG and the approximate scale factor SC using all of the four elements h11, h12, h21, and h22 of the first submatrix SM1.

In the present embodiment, as shown in the second equation EQ2, the average of “h11” and “h22” is adopted as SC*cos(AG) (this value is referred to as a first value Pc). As shown in the third equation EQ3, the average of “h21” and “−h12” is adopted as SC*sin(AG) (this value is referred to as a second value Ps). The equations EQ4 and EQ5 are derived from the equations EQ2 and EQ3. As shown in the fourth equation EQ4, the approximate scale factor SC is calculated as the square root of the sum of the square of the first value Pc and the square of the second value Ps. As shown in the fifth equation EQ5, the approximate angle AG is calculated as the inverse function of the tangent function (the argument is “Ps/Pc”). In this way, each of SC*cos(AG) and SC*sin(AG) is calculated by using the average of the corresponding two elements of the first submatrix SM1. Thus, the influence of parameters other than the angle of rotation and the scale factor is mitigated.

In S160 (FIG. 14A), the processor 110 calculates the approximate scale factor SC and the approximate angle AG from the homography matrix H according to the equations EQ4 and EQ5 of FIG. 14B.

In S170, the processor 110 determines whether the object indicator value is within an acceptable range. In the present embodiment, when the approximate scale factor SC is within an acceptable scale factor range (a range higher than or equal to a lower limit SC1 and lower than or equal to an upper limit SC2) and the approximate angle AG is within an acceptable angle range (a range higher than or equal to a lower limit AG1 and lower than or equal to an upper limit AG2), the processor 110 determines that the object indicator value is within the acceptable range. As described below, the acceptable scale factor range and the acceptable angle range are determined in advance.

In the present embodiment, when the label L (FIG. 2A) is captured, the relative arrangement between the product 300 and the capturing device 400 is adjusted to a predetermined arrangement suitable for capturing. Thus, when a plurality of labels without abnormality are processed, the approximate scale factor SC is approximately constant, and the approximate angle AG is approximately constant. The approximate scale factor SC is determined according to, for example, a ratio of the resolution (that is, pixel density) between the captured image ip and the normal image iq and a distance between the capturing device 400 (FIG. 2A) and the label L. The approximate angle AG may be approximately zero degrees, for example.

When there is an abnormality related to the target label Lt, an inappropriate matching pair may be used in the calculation of the homography matrix H, similar to the example of FIG. 7H. The elements of the homography matrix H (for example, the elements h11, h12, h21, and h22 of the first submatrix SM1) may be abnormal values caused by an abnormality. Due to abnormal values, the approximate scale factor SC may differ significantly from the appropriate value, and the approximate angle AG may differ significantly from the appropriate value.

Various abnormalities may occur as abnormalities related to the target label Lt. As in the target surface SF1t of the target label Lt of FIG. 4A, the target surface SF1t may include an abnormal portion. In this case, one or both of the approximate scale factor SC and the approximate angle AG may differ significantly from the corresponding appropriate values. Even when the target surface SF It does not include an abnormal portion, the target label Lt may be inclined relative to the appropriate orientation with respect to the product 300. In this case, the approximate angle AG may differ significantly from the appropriate value. Even when the target surface SF1t does not include an abnormal portion, the target label Lt having a size different from the appropriate size may be affixed to the product 300. In this case, the approximate scale factor SC may differ significantly from the appropriate value. Further, a label for another product different from the product 300 may be erroneously affixed to the product 300. In this case, one or both of the approximate scale factor SC and the approximate angle AG may differ significantly from the corresponding appropriate values.

The acceptable scale factor range (in the present embodiment, the lower limit SC1 and the upper limit SC2) is experimentally determined in advance such that the approximate scale factor SC is within the acceptable scale factor range when there is no abnormality related to the target label Lt and that the approximate scale factor SC is outside the acceptable scale factor range when the approximate scale factor SC is significantly different from the appropriate value due to the abnormality related to the target label Lt. Similarly, the acceptable angle range (in the embodiment, the lower limit AG1 and the upper limit AG2) is experimentally determined in advance such that the approximate angle AG is within the acceptable angle range when there is no abnormality related to the target label Lt and that the approximate angle AG is outside the acceptable angle range when the approximate angle AG is significantly different from the appropriate value due to the abnormality related to the target label Lt.

When the object indicator value is outside the acceptable range (S170: No), in S180 the processor 110 determines that there is an abnormality associated with the target label Lt and sets an inspection result to object abnormality which indicates an abnormality associated with the target label Lt. The processor 110 stores data indicating the inspection result in the memory 115 (for example, the nonvolatile memory 130). Then, the processor 110 ends the inspection process.

If the object indicator value is within the acceptable range (S170: Yes), the processor 110 moves to S190 (FIG. 3). The processing of S190 and S195 may be the same as the processing of the first embodiment or the processing of the second embodiment.

As described above, in the present embodiment, in S160 the processor 110 calculates the approximate rotation angle AG that approximates the rotation angle by the homography matrix H and the approximate scale factor SC that approximates the scale factor by the homography matrix H. The homography matrix H is a matrix indicating homography transformation (S190 (FIG. 3)) on the captured image ip. As described in S170 and S180, in a particular case including a first case where the approximate rotation angle AG is outside the acceptable angle range or a second case where the approximate scale factor SC is outside the acceptable scale factor range (S170: No), the processor 110 determines that there is an abnormality related to the target object (S180). Thus, the processor 110 performs appropriate determination regarding various abnormalities including an inclination abnormality and a size abnormality of the target surface SF it.

In the present embodiment, as described with reference to FIG. 5A, the homography transformation of the captured image ip in S190 (FIG. 3) includes the coordinate transformation by the homography matrix H. The homography matrix H includes elements h11, h12, h21, and h22 forming the first submatrix SM1 of two rows and two columns. The first submatrix SM1 represents coordinate transformation including rotation and scaling between a two-dimensional coordinate system (indicating coordinates x and y) indicating positions on the captured image ip and a two-dimensional coordinate system (indicating coordinates x′ and y′) indicating positions on the transformed image ipc. As described with reference to FIG. 14B, in S160 (FIG. 14A), the processor 110 calculates both the approximate rotation angle AG and the approximate scale factor SC based on the elements h11, h12, h21, and h22 of the first submatrix SM1. In this way, the processor 110 calculates an appropriate approximate rotation angle AG and an appropriate approximate scale factor SC based on the elements h11, h12, h21, and h22 of the first submatrix SM1.

### D. Fourth Embodiment

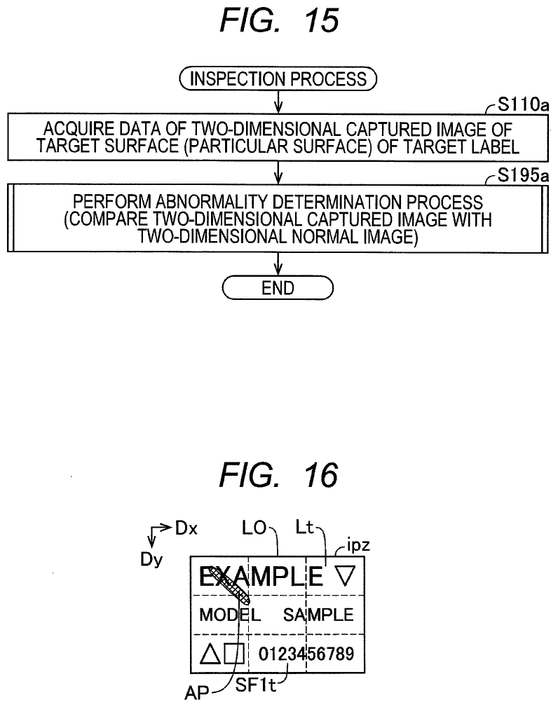

FIG. 15 is a flowchart showing another embodiment of the inspection process. The difference from the inspection process of FIG. 3 is that the homography transformation (S130, S140, S150, and S190) for acquiring the transformed image is omitted. S110a and S195a are modified from S110 and S195 in FIG. 3 as follows.

In S110a, the processor 110 (FIG. 1) acquires data of a captured image for the inspection process from data of an output image which is a captured image outputted from the capturing device 400 (FIG. 2A). FIG. 16 is a diagram showing an example of the captured image for the inspection process. A captured image ipz represents the particular surface SF1t of the target label Lt. In the present embodiment, the position, orientation, and size of the target label Lt in the captured image ipz are substantially the same as the position, orientation, and size of the normal label Ls in the normal image iq (FIG. 7A).

In order to acquire the captured image ipz, when the label L (FIG. 2A) is captured, the relative arrangement between the product 300 and the capturing device 400 is adjusted to a predetermined reference arrangement suitable for image capturing. The reference arrangement is experimentally determined in advance such that the distortion of the shape of the target label Lt in the output image outputted from the capturing device 400 is small. For example, the capturing device 400 in the reference arrangement captures the target label Lt from the front of the target label Lt.

In S110a, the processor 110 acquires the output image from the capturing device 400 and detects the target label Lt from the output image. The processor 110 acquires, as the captured image ipz, a partial image representing the detected target label Lt in the output image. The target label Lt may be detected by various methods. For example, the processor 110 may detect the target label Lt by template matching using a template image of the label L (for example, the normal image iq (FIG. 7A)). The processor 110 may detect the target label Lt by using an object detection model trained to detect the label L. Further, a predetermined portion in the output image may be acquired as the captured image ipz. When the resolution of the partial image acquired from the output image (that is, the number of pixels in the first direction Dx and the number of pixels in the second direction Dy) is different from the resolution of the normal image iq, the processor 110 performs resolution conversion of the partial image to acquire the captured image ipz having the same resolution as the resolution of the normal image iq.

As described above, the position, orientation, and size of the target label Lt in the captured image ipz are substantially the same as the position, orientation, and size of the normal label Ls in the normal image iq (FIG. 7A), respectively. Thus, the processor 110 performs the abnormality determination process of S195a (FIG. 15) by using the captured image ipz, without performing the homography transformation (S130 to S190 (FIG. 3)) from the captured image to the transformed image.

In S195a, the processor 110 performs an abnormality determination process of determining whether the particular surface SF1t of the target label Lt has an abnormality by comparing the captured image ipz with the normal image iq (FIG. 4C). The abnormality determination process of S195a is the same as the abnormality determination process of S195 (FIG. 3) (that is, the abnormality determination process of FIG. 6) except that the captured image ipz is used instead of the transformed image ipc. The abnormality determination process of S195 in any of the above embodiments may be applied to S195a in the present embodiment (here, the transformed image ipc is replaced with the captured image ipz). For example, the processor 110 may execute the abnormality determination process using the blocks in FIGS. 7A to 7F or the abnormality determination process using the blocks in FIGS. 12A to 12D and FIGS. 13A to 13D. As shown in FIGS. 7D and 16, the captured image ipz is substantially the same as the transformed image ipc. Thus, the present embodiment provides the same advantages as the previous embodiments.

### E. Modifications

(1) The method of detecting keypoints may be various other methods instead of the above-described method. For example, the processor 110 may detect a plurality of keypoints by template matching using a plurality of template images prepared in advance. As the template image, an image of a characteristic portion in the particular surface SF1 of the normal label Ls may be used. The processor 110 may adopt, as a matching pair, a pair of keypoints detected from two images (for example, the captured image ip and the normal image iq) using the same template image.

(2) As in the embodiments of FIGS. 12A to 12D and 13A to 13D, the N first type partial images (for example, the target block images pa1 to pa9) may include the first type overlapping partial image that partially overlaps one or more other first type partial images. Here, a total number Q of the first type overlapping partial images may be any number greater than or equal to 2 and less than or equal to N. In this way, the N first type partial images may include N-Q (N minus Q) first type partial images that do not overlap other first type partial images. For example, other target block images overlapping the target block image pd4 (FIG. 13D) may be omitted. The above description is also applied to the N second type partial images (for example, the normal block images qa1 to qa9). For example, the N second type partial images may include N-Q (N minus Q) second type partial images that do not overlap other second type partial images.

(3) The positions with respect to the labels Lt and Ls may be different between the first type partial image (for example, the target block image pa1 (FIG. 7E)) and the second type partial image (for example, the normal block image qa1 (FIG. 7B)) which are associated with each other. For example, the positions of the target block images pa1 to pa9 with respect to the target label Lt may be slightly shifted in the first direction Dx with respect to the positions of the normal block images qa1 to qa9 with respect to the normal label Ls. Further, the size and the shape may be different between the first type partial image and the second type partial image associated with each other.

In any case, the first type partial image and the second type partial image associated with each other may include a common portion of the labels Lt and Ls. According to this configuration, the processor 110 calculates the homography matrix by using a plurality of matching pairs indicating a common portion of the labels Lt and Ls. The processor 110 appropriately determines whether the particular surface SF It has an abnormal portion by using the homography matrix, similarly to the embodiment of FIGS. 7G and 7H.

(4) The label L may include a portion where an abnormality is likely to occur and a portion where an abnormality is unlikely to occur. In this case, the portion where an abnormality is unlikely to occur may be excluded from the plurality of partial images. That is, the plurality of first type partial images (for example, the target block images pa1 to pa9 (FIG. 7E)) may be arranged only in a portion (for example, a portion where an abnormality is likely to occur) of the target label Lt. The above description is also applied to a plurality of second type partial images (for example, the normal block images qa1 to qa9 (FIG. 7B)). A portion of the normal label Ls may be excluded from the plurality of second type partial images.

(5) The size and shape of each of the plurality of first type partial images (for example, the target block images pa1 to pa9 (FIG. 7E)) are experimentally determined in advance such that an appropriate determination regarding an abnormality of the particular surface SF1t is made. When the first type partial image is small, the total number of appropriate matching pairs decreases, and thus it may be difficult to calculate an appropriate homography matrix. When the first type partial image is large, the total number of appropriate matching pairs increases, and thus, even when the first type partial image includes an abnormal portion, a homography matrix is calculated without using an inappropriate matching pair. The above description is also applied to a plurality of second type partial images (for example, the normal block images qa1 to qa9 (FIG. 7B)).

(6) The abnormality indicator value Ad calculated in S270 (FIG. 6) may be various values indicating the degree of difference between the homography matrix and the identity matrix. The abnormality indicator value Ad may be various values calculated based on one or more elements of the four elements of the first submatrix SM1. For example, the abnormality indicator value Ad may be the sum of the absolute value of h12 and the absolute value of h21. In addition to one or more elements of the first submatrix SM1, other elements (for example, one or more elements of the second submatrix SM2 or one or more elements of the third submatrix SM3) may be used to calculate the abnormality indicator value Ad. For example, the abnormality indicator value Ad may be the sum of the absolute values of eight differences of eight elements other than h33 between the homography matrix and the identity matrix. The abnormality indicator value Ad may be the sum of the squares of the differences between the plurality of elements.

As the abnormality indicator value Ad, one or both of the approximate scale factor SC and the approximate angle AG described with reference to FIGS. 14A and 14B may be used. The approximate scale factor SC and the approximate angle AG also indicate the degree of difference between the homography matrix and the identity matrix.

(7) The process of S195 (FIG. 3) and S195a (FIG. 15) (that is, the process of determining whether the particular surface SF1t of the target label Lt has an abnormality) may be various other processes instead of the process of FIG. 6. The processor 110 may generate data of a difference image representing a difference in color value for each pixel between the transformed image ipc and the normal image iq. Then, the processor 110 may determine whether the particular surface SF1t has an abnormality by using the difference image. For example, the processor 110 may determine that the particular surface SF1t has an abnormality when a representative value of a plurality of differences of a plurality of pixels (for example, a summary statistic such as a sum or a mean) is greater than or equal to a representative threshold. The processor 110 may determine that the particular surface SF1t has an abnormality when the total number of pixels having a difference greater than or equal to a difference threshold is greater than or equal to a total number threshold. The representative threshold, the difference threshold, and the total number threshold may be experimentally determined in advance. The processor 110 may determine whether the particular surface SF1t has an abnormality by using a machine learning model configured to classify the difference image into an image having an abnormality and an image having no abnormality. For the determination of an abnormality using a machine learning model, for example, a technique called PaDiM (a Patch Distribution Modeling Framework for Anomaly Detection and Localization) may be adopted.

(8) The method of calculating the approximate scale factor SC and the approximate angle AG may be various other methods instead of the method of FIG. 14B. The approximate scale factor SC and the approximate angle AG may be calculated based on elements forming the first submatrix SM1. That is, the approximate scale factor SC and the approximate angle AG may be calculated based on one or more elements of the four elements of the first submatrix SM1. For example, the average of h11 and h22 may be used as the approximate scale factor SC. The argument of the inverse function of the tangent function of the fifth equation EQ5 may be “h21/h11” or “−h12/h22”.

In S160 and S170 of FIG. 14A, either one of the approximate scale factor SC and the approximate angle AG may be used. That is, the processor 110 may determine that there is an abnormality related to the target label Lt represented by the captured image ip in one case selected in advance from a first case where the approximate angle AG is outside the acceptable angle range and a second case where the approximate scale factor SC is outside the acceptable scale factor range. In any case, the particular case where it is determined that there is an abnormality may further include another case. For example, the processor 110 may calculate the abnormality indicator value Ad (for example, the abnormality indicator value Ad of FIG. 9C) from the homography matrix H calculated in S150 (FIG. 4). Then, the processor 110 may determine that there is an abnormality related to the target label Lt when the abnormality indicator value Ad is greater than or equal to a particular threshold. This threshold may be different from the threshold Adth in S310 (FIG. 10).

(9) In each of the embodiments described above, the processor 110 may generate data of a transformed image by performing homography transformation on the normal image iq instead of performing homography transformation on the captured image ip. Then, the processor 110 may determine whether the particular surface SF1t of the target label Lt has an abnormality by comparing the transformed image with the captured image. In this case, in S190 (FIG. 3), the processor 110 performs homography transformation on the normal image iq to generate a transformed image (referred to as a transformed normal image). In the abnormality determination process in S190 (FIG. 6), the processor 110 compares the captured image with the transformed normal image. Here, the plurality of normal block images and the plurality of target block images are arranged such that each block image includes a portion of the labels Ls and Lt. The positions, sizes, and shapes of the plurality of block images may be determined in advance. For example, the processor 110 may acquire a plurality of normal block images on the transformed normal image by homography transformation of a predetermined plurality of normal block images (for example, the normal block images qa1 to qa9 (FIG. 7B)) of the normal image iq. The position, size, and shape of the target block on the captured image may be the same as the position, size, and shape of the normal block image associated with the target block image (here, the position, size, and shape on the transformed normal image). Alternatively, the processor 110 may detect the labels Ls and Lt from the transformed image and the captured image, and determine the positions, sizes, and shapes of the plurality of block images in accordance with the positions of the detected labels Ls and Lt (in this case, the sizes and shapes may be determined in advance).

(10) The process of acquiring the data of the captured image used in the inspection process may be various other processes instead of the process described above. For example, the processor 110 may acquire the data of the captured image by performing a correction process of correcting characteristics of the capturing device 400, such as distortion correction of a lens (not shown), on the output image outputted from the capturing device 400 (FIG. 2A). The parameters used in the correction process are also referred to as camera internal parameters. The data of the captured image may be supplied to the data processing apparatus 100 by another apparatus (for example, a computer such as a smartphone) different from the data processing apparatus 100. The processor 110 may execute the inspection process (for example, the inspection process of each of the embodiments of FIGS. 3, 14, and 15) by using the supplied captured image data. Here, the other apparatus may generate data of a transformed captured image by performing homography transformation based on the normal image iq on the output image outputted from the capturing device 400, and supply the data of the transformed captured image to the data processing apparatus 100.

(11) The process of determining whether the particular surface SF1t of the target label Lt has an abnormality may be various other processes instead of the process described above. For example, the processor 110 may detect a plurality of keypoints by analyzing data of the normal image iq in the inspection process. In this case, the data of the normal keypoints D1 (FIG. 1) may be omitted. The data of the normal image iq may be stored in the memory 115 (for example, the nonvolatile memory 130) in advance. The processor 110 may acquire the keypoints and the feature descriptors of the normal block image by analyzing the data of the normal block image. In this case, the data of the normal block keypoints D2 (FIG. 1) may be omitted.

(12) The target object which is the object of the processing target is not limited to the label L (FIG. 2B), and may be any object. The target object may be an object provided in a product (for example, a multifunction peripheral). The target object may include one or more elements selected from a plurality of elements including a label sheet, a nameplate (for example, a three-dimensional inscription), and a painted pattern. The particular surface which is the surface of the processing target of the target object may be any surface of the target object. The particular surface may include one or both of a flat portion of the target object and a three-dimensional portion of the target object.

(13) The image processing apparatus that processes the captured image and the normal image may be various other apparatuses (for example, a digital camera or a smartphone) instead of the data processing apparatus 100 (FIG. 1) described above. A plurality of apparatuses (for example, computers) that communicate with each other via a network may share some of the functions of image processing performed by the image processing apparatus and provide the functions of image processing as a whole (a system including these apparatuses serves as the image processing apparatus).

In the embodiments and the modifications described above, a part of the configuration realized by hardware may be replaced by software, and conversely, a part or all of the configuration realized by software may be replaced by hardware. For example, the function of calculating the homography matrix (S150 (FIG. 3) and S250 (FIG. 6)) may be implemented by a dedicated hardware circuit.

When a part or all of the functions of the present disclosure are realized by a computer program, the program may be provided in a form stored in a computer-readable storage medium (for example, a non-transitory storage medium). The program may be used in a state of being stored in the same storage medium as that at the time when the program is provided or a different storage medium (a computer-readable storage medium). The “computer-readable storage medium” is not limited to a portable storage medium such as a memory card or a CD-ROM, and may include an internal memory in a computer such as various ROMs or an external memory connected to a computer such as a hard disk drive.

In the above-described embodiments, the processor 110 performs each step of the flowcharts in FIGS. 3, 15 and so on. Alternatively, a plurality of processors may be provided, and the plurality of processors may individually or collectively perform the described steps. In this case, one of the plurality of processors may perform each of the described steps, or two or more of the plurality of processors may perform the described steps in a distributed manner. For example, one processor may perform a first step, another processor may perform a second step, and so on.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided as appropriate.

What is claimed is:

1. A non-transitory computer-readable storage medium storing a set of program instructions for a computer comprising a processor, the set of program instructions, when executed by the processor, causing the computer to perform:
acquiring a two-dimensional captured image of a particular surface of a target object;
keypoint matching between the two-dimensional captured image and a two-dimensional normal image representing a normal particular surface;
generating a transformed image by performing homography transformation on a first image in accordance with a result of the keypoint matching, the first image being one of the two-dimensional captured image and the two-dimensional normal image; and
determining whether the particular surface of the target object has an abnormality by comparing a second image with the transformed image, the second image being an other one of the two-dimensional captured image and the two-dimensional normal image.

2. The non-transitory computer-readable storage medium according to claim 1, wherein the determining whether the particular surface of the target object has an abnormality includes:
acquiring, from the transformed image, N (N is an integer greater than or equal to two) first type partial images including different portions of a first type particular surface, the first type particular surface being a particular surface represented by the transformed image;
performing keypoint matching between a first type partial image and a second type partial image associated with each other, each of N combinations including the first type partial image and the second type partial image associated with each other, N second type partial images including different portions of a second type particular surface, the second type particular surface being a particular surface represented by the second image, the first type partial image and the second type partial image associated with each other including a common portion;
calculating N homography matrices in accordance with N results of the keypoint matching;
calculating a degree of difference between an identity matrix and each of the N homography matrices; and
determining whether the particular surface of the target object has an abnormality by comparing each of N degrees of difference with a reference for the degree of difference.

3. The non-transitory computer-readable storage medium according to claim 2, wherein the N first type partial images includes Q (Q is an integer greater than or equal to two and less than or equal to N) first type overlapping partial images, each of the Q first type overlapping partial images being the first type partial image that partially overlaps one or more other first type partial images, the Q first type overlapping partial images including a particular first type overlapping partial image;
wherein the N second type partial images includes Q second type overlapping partial images, each of the Q second type overlapping partial images being the second type partial image that partially overlaps one or more other second type partial images, the Q second type overlapping partial images including a particular second type overlapping partial image, the particular second type overlapping partial image being associated with the particular first type overlapping partial image; and
wherein the one or more other second type partial images partially overlapping the particular second type overlapping partial image are associated with respective ones of the one or more other first type partial images partially overlapping the particular first type overlapping partial image.

4. The non-transitory computer-readable storage medium according to claim 2, wherein each of the N homography matrices includes elements forming a submatrix of two rows and two columns representing coordinate transformation including rotation and scaling between a two-dimensional coordinate system indicating positions on the first type partial image and a two-dimensional coordinate system indicating positions on the second type partial image; and
wherein the degree of difference indicates a degree of difference between the submatrix of two rows and two columns and an identity matrix of two rows and two columns.

5. The non-transitory computer-readable storage medium according to claim 1, wherein the set of program instructions, when executed by the processor, further causes the computer to perform:
determining that there is an abnormality related to the target object in a particular case including one or both of a first case and a second case, the first case being a case where an approximate rotation angle that approximates a rotation angle by the homography transformation on the first image is outside an acceptable angle range, the second case being a case where an approximate scale factor that approximates a scale factor by the homography transformation on the first image is outside an acceptable scale factor range.

6. The non-transitory computer-readable storage medium according to claim 5, wherein the homography transformation on the first image includes coordinate transformation by a first homography matrix;
wherein the first homography matrix includes elements forming a submatrix of two rows and two columns representing coordinate transformation including rotation and scaling between a two-dimensional coordinate system indicating positions on the first image and a two-dimensional coordinate system indicating positions on the transformed image; and
wherein the determining that there is an abnormality related to the target object in the particular case includes calculating one or both of the approximate rotation angle and the approximate scale factor based on the elements forming the submatrix of two rows and two columns of the first homography matrix.

7. The non-transitory computer-readable storage medium according to claim 3, wherein the one or more other first type partial images partially overlapping the particular first type overlapping partial image include:
a first-direction-overlapping first type partial image shifted in a first direction from the particular first type overlapping partial image by half a length of the particular first type overlapping partial image in the first direction;
a second-direction-overlapping first type partial image shifted in a second direction from the particular first type overlapping partial image by half a length of the particular first type overlapping partial image in the second direction, the second direction being perpendicular to the first direction; and
a first-and-second-direction-overlapping first type partial image shifted in the second direction from the first-direction-overlapping first type partial image by half a length of the particular first type overlapping partial image in the second direction;
wherein the one or more other second type partial images partially overlapping the particular second type overlapping partial image include:
a first-direction-overlapping second type partial image shifted in the first direction from the particular second type overlapping partial image by half a length of the particular second type overlapping partial image in the first direction;
a second-direction-overlapping second type partial image shifted in the second direction from the particular second type overlapping partial image by half a length of the particular second type overlapping partial image in the second direction; and
a first-and-second-direction-overlapping second type partial image shifted in the second direction from the first-direction-overlapping second type partial image by half a length of the particular second type overlapping partial image in the second direction;
wherein the first-direction-overlapping first type partial image and the first-direction-overlapping second type partial image are associated with each other;
wherein the second-direction-overlapping first type partial image and the second-direction-overlapping second type partial image are associated with each other; and
wherein the first-and-second-direction-overlapping first type partial image and the first-and-second-direction-overlapping second type partial image are associated with each other.

8. A non-transitory computer-readable storage medium storing a set of program instructions for a computer comprising a processor, the set of program instructions, when executed by the processor, causing the computer to perform:
acquiring a two-dimensional captured image of a particular surface of a target object; and
determining whether the particular surface of the target object has an abnormality by comparing the two-dimensional captured image with a two-dimensional normal image representing a normal particular surface, the determining whether the particular surface of the target object has an abnormality including:
acquiring, from the two-dimensional captured image, N (N is an integer greater than or equal to two) first type partial images including different portions of a first type particular surface, the first type particular surface being a particular surface represented by the two-dimensional captured image;
performing keypoint matching between a first type partial image and a second type partial image associated with each other, each of N combinations including the first type partial image and the second type partial image associated with each other, N second type partial images including different portions of a second type particular surface, the second type particular surface being a particular surface represented by the two-dimensional normal image, the first type partial image and the second type partial image associated with each other including a common portion;
calculating N homography matrices in accordance with N results of the keypoint matching;
calculating a degree of difference between an identity matrix and each of the N homography matrices; and
determining whether the particular surface of the target object has an abnormality by comparing each of N degrees of difference with a reference for the degree of difference.

9. The non-transitory computer-readable storage medium according to claim 8, wherein the N first type partial images includes Q (Q is an integer greater than or equal to two and less than or equal to N) first type overlapping partial images, each of the Q first type overlapping partial images being the first type partial image that partially overlaps one or more other first type partial images, the Q first type overlapping partial images including a particular first type overlapping partial image;
wherein the N second type partial images includes Q second type overlapping partial images, each of the Q second type overlapping partial images being the second type partial image that partially overlaps one or more other second type partial images, the Q second type overlapping partial images including a particular second type overlapping partial image, the particular second type overlapping partial image being associated with the particular first type overlapping partial image; and
wherein the one or more other second type partial images partially overlapping the particular second type overlapping partial image are associated with respective ones of the one or more other first type partial images partially overlapping the particular first type overlapping partial image.

10. The non-transitory computer-readable storage medium according to claim 8, wherein each of the N homography matrices includes elements forming a submatrix of two rows and two columns representing coordinate transformation including rotation and scaling between a two-dimensional coordinate system indicating positions on the first type partial image and a two-dimensional coordinate system indicating positions on the second type partial image; and
wherein the degree of difference indicates a degree of difference between the submatrix of two rows and two columns and an identity matrix of two rows and two columns.

11. An image processing apparatus comprising:
a processor; and
a memory storing instructions, the instructions, when executed by the processor, causing the image processing apparatus to perform:
acquiring a two-dimensional captured image of a particular surface of a target object;
keypoint matching between the two-dimensional captured image and a two-dimensional normal image representing a normal particular surface;
generating a transformed image by performing homography transformation on a first image in accordance with a result of the keypoint matching, the first image being one of the two-dimensional captured image and the two-dimensional normal image; and
determining whether the particular surface of the target object has an abnormality by comparing a second image with the transformed image, the second image being an other one of the two-dimensional captured image and the two-dimensional normal image.

12. The image processing apparatus according to claim 11, wherein the determining whether the particular surface of the target object has an abnormality includes:
acquiring, from the transformed image, N (N is an integer greater than or equal to two) first type partial images including different portions of a first type particular surface, the first type particular surface being a particular surface represented by the transformed image;
performing keypoint matching between a first type partial image and a second type partial image associated with each other, each of N combinations including the first type partial image and the second type partial image associated with each other, N second type partial images including different portions of a second type particular surface, the second type particular surface being a particular surface represented by the second image, the first type partial image and the second type partial image associated with each other including a common portion;
calculating N homography matrices in accordance with N results of the keypoint matching;
calculating a degree of difference between an identity matrix and each of the N homography matrices; and
determining whether the particular surface of the target object has an abnormality by comparing each of N degrees of difference with a reference for the degree of difference.

13. The image processing apparatus according to claim 12, wherein the N first type partial images includes Q (Q is an integer greater than or equal to two and less than or equal to N) first type overlapping partial images, each of the Q first type overlapping partial images being the first type partial image that partially overlaps one or more other first type partial images, the Q first type overlapping partial images including a particular first type overlapping partial image;
wherein the N second type partial images includes Q second type overlapping partial images, each of the Q second type overlapping partial images being the second type partial image that partially overlaps one or more other second type partial images, the Q second type overlapping partial images including a particular second type overlapping partial image, the particular second type overlapping partial image being associated with the particular first type overlapping partial image; and
wherein the one or more other second type partial images partially overlapping the particular second type overlapping partial image are associated with respective ones of the one or more other first type partial images partially overlapping the particular first type overlapping partial image.

14. The image processing apparatus according to claim 12, wherein each of the N homography matrices includes elements forming a submatrix of two rows and two columns representing coordinate transformation including rotation and scaling between a two-dimensional coordinate system indicating positions on the first type partial image and a two-dimensional coordinate system indicating positions on the second type partial image; and
wherein the degree of difference indicates a degree of difference between the submatrix of two rows and two columns and an identity matrix of two rows and two columns.

15. The image processing apparatus according to claim 11, wherein the instructions, when executed by the processor, further cause the image processing apparatus to perform:
determining that there is an abnormality related to the target object in a particular case including one or both of a first case and a second case, the first case being a case where an approximate rotation angle that approximates a rotation angle by the homography transformation on the first image is outside an acceptable angle range, the second case being a case where an approximate scale factor that approximates a scale factor by the homography transformation on the first image is outside an acceptable scale factor range.

16. The image processing apparatus according to claim 15, wherein the homography transformation on the first image includes coordinate transformation by a first homography matrix;
wherein the first homography matrix includes elements forming a submatrix of two rows and two columns representing coordinate transformation including rotation and scaling between a two-dimensional coordinate system indicating positions on the first image and a two-dimensional coordinate system indicating positions on the transformed image; and
wherein the determining that there is an abnormality related to the target object in the particular case includes calculating one or both of the approximate rotation angle and the approximate scale factor based on the elements forming the submatrix of two rows and two columns of the first homography matrix.

17. The image processing apparatus according to claim 13, wherein the one or more other first type partial images partially overlapping the particular first type overlapping partial image include:
a first-direction-overlapping first type partial image shifted in a first direction from the particular first type overlapping partial image by half a length of the particular first type overlapping partial image in the first direction;
a second-direction-overlapping first type partial image shifted in a second direction from the particular first type overlapping partial image by half a length of the particular first type overlapping partial image in the second direction, the second direction being perpendicular to the first direction; and
a first-and-second-direction-overlapping first type partial image shifted in the second direction from the first-direction-overlapping first type partial image by half a length of the particular first type overlapping partial image in the second direction;
wherein the one or more other second type partial images partially overlapping the particular second type overlapping partial image include:
a first-direction-overlapping second type partial image shifted in the first direction from the particular second type overlapping partial image by half a length of the particular second type overlapping partial image in the first direction;
a second-direction-overlapping second type partial image shifted in the second direction from the particular second type overlapping partial image by half a length of the particular second type overlapping partial image in the second direction; and
a first-and-second-direction-overlapping second type partial image shifted in the second direction from the first-direction-overlapping second type partial image by half a length of the particular second type overlapping partial image in the second direction;
wherein the first-direction-overlapping first type partial image and the first-direction-overlapping second type partial image are associated with each other;
wherein the second-direction-overlapping first type partial image and the second-direction-overlapping second type partial image are associated with each other; and
wherein the first-and-second-direction-overlapping first type partial image and the first-and-second-direction-overlapping second type partial image are associated with each other.
